(19) United States
(12) Patent Application Publication
(10) Pub. No.: US 2024/0015637 A1
(43) Pub. Date: Jan. 11, 2024

(54) TECHNIQUES FOR RELAYING SYSTEM INFORMATION OVER A SIDELINK

(71) Applicant: QUALCOMM Incorporated, San Diego, CA (US)

(72) Inventors: Peng CHENG, Beijing (CN); Karthika PALADUGU, Hyderabad, (IN); Hong CHENG, Basking Ridge, NJ (US); Soo Bum LEE, San Diego, CA (US); Ozcan OZTURK, San Diego, CA (US); Gavin Bernard HORN, La Jolla, CA (US)

(21) Appl. No.: 18/253,656

(22) PCT Filed: Jan. 15, 2021
(86) PCT No.: PCT/CN2021/072188

§ 371 Date: May 19, 2023

(51) Int. Cl. H04W 48/08

(52) U.S. Cl. CPC H04W 48/08; H04W 88/04

(57) ABSTRACT

Methods, systems, and devices for wireless communications are described. In some systems, a first user equipment (UE) that is out-of-coverage of a base station and a second UE that is in-coverage of the base station may support signaling exchanges for transmitting or receiving a discovery message, an essential system information block (E-SIB), common SIB updates, or on-demand SIBs within a relaying network before and after a relay connection between the first UE and the second UE. The first UE may receive the discovery message and the E-SIB via same or different signaling and may acquire or decode the E-SIB according to various techniques. The first UE may receive common SIB updates via a dedicated logical channel between the first UE and the second UE and the first UE may initiate on-demand SIB acquisition after establishment of the relay connection and based on a connection type of the first UE.

### CROSS REFERENCE

The present application is a 371 national stage filing of International PCT Application No. PCT/CN2021/072188 by CHENG et al. entitled “TECHNIQUES FOR RELAYING SYSTEM INFORMATION OVER A SIDELINK,” filed Jan. 15, 2021, which is assigned to the assignee hereof, and which is expressly incorporated by reference in its entirety herein.

### INTRODUCTION

The present disclosure relates to relaying sidelink information, including managing signaling exchanges for forwarding system information between peer devices.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a first UE is described. The method may include receiving, from a second UE via broadcast signaling, a first system information transmission including one or more parameters associated with a relay connection with the second UE. The method may further include transmitting, to the second UE, a request associated with a base station for a second system information transmission, the request based on the relay connection with the second UE and a connection state of the first UE, the relay connection based on the one or more parameters in the first system information transmission. The method may additionally include receiving, from the second UE, the second system information transmission in response to the request.

An apparatus for wireless communication at a first UE is described. The apparatus may include a processor and memory coupled to the processor. The processor and memory may be configured to receive, from a second UE via broadcast signaling, a first system information transmission including one or more parameters associated with a relay connection with the second UE. The processor and memory may be further configured to transmit, to the second UE, a request associated with a base station for a second system information transmission, the request based on the relay connection with the second UE and a connection state of the first UE, the relay connection based on the one or more parameters in the first system information transmission. The processor and memory may be further configured to to receive, from the second UE, the second system information transmission in response to the request.

Another apparatus for wireless communication at a first UE is described. The apparatus may include means for receiving, from a second UE via broadcast signaling, a first system information transmission including one or more parameters associated with a relay connection with the second UE. The apparatus may further include means for transmitting, to the second UE, a request associated with a base station for a second system information transmission, the request based on the relay connection with the second UE and a connection state of the first UE, the relay connection based on the one or more parameters in the first system information transmission. The apparatus may additionally include means for receiving, from the second UE, the second system information transmission in response to the request.

A non-transitory computer-readable medium storing code for wireless communication at a first UE is described. The code may include instructions executable by a processor to receive, from a second UE via broadcast signaling, a first system information transmission including one or more parameters associated with a relay connection with the second UE. The code may further include instructions executable by a processor to transmit, to the second UE, a request associated with a base station for a second system information transmission, the request based on the relay connection with the second UE and a connection state of the first UE, the relay connection based on the one or more parameters in the first system information transmission. The code may additionally include instructions executable by a processor to receive, from the second UE, the second system information transmission in response to the request.

Some examples of the method, apparatuses, and non-transitory computer-readable medium described herein may further include operations, features, means, or instructions for receiving, from the second UE, a discovery message including a cell identifier (ID) associated with the second UE, a public land mobile network (PLMN) ID associated with the second UE, and access stratum information relating to a selection criteria associated with the second UE.

In some examples of the method, apparatuses, and non-transitory computer-readable medium described herein, the discovery message includes the first system information transmission.

In some examples of the method, apparatuses, and non-transitory computer-readable medium described herein, the discovery message may be received via different signaling than the first system information transmission. The method, apparatuses, and non-transitory computer-readable medium may include further operations, features, means, or instructions for receiving, from the second UE, a configuration of a periodicity of the first system information transmission, the receiving of the first system information transmission being based on the configuration of the periodicity of the first system information transmission.

In some examples of the method, apparatuses, and non-transitory computer-readable medium described herein, the first system information transmission may be received via a medium access control (MAC) control element (MAC-CE), sidelink control information (SCI), packet data convergence protocol (PDCP) signaling, radio resource control (RRC) signaling, or any combination thereof.

Some examples of the method, apparatuses, and non-transitory computer-readable medium described herein may further include operations, features, means, or instructions for decoding the first system information transmission subsequent to receiving the discovery message and prior to establishing the relay connection with the second UE.

Some examples of the method, apparatuses, and non-transitory computer-readable medium described herein may further include operations, features, means, or instructions for selecting to establish the relay connection with the second UE based on the discovery message and decoding the first system information transmission based on establishing the relay connection with the second UE.

Some examples of the method, apparatuses, and non-transitory computer-readable medium described herein may further include operations, features, means, or instructions for decoding the first system information transmission based on one or more ciphering and integrity protection algorithms.

Some examples of the method, apparatuses, and non-transitory computer-readable medium described herein may further include operations, features, means, or instructions for receiving, from the second UE, a group key, the group key shared among one or more UEs including the first UE and utilizing the group key in the decoding of the first system information transmission.

Some examples of the method, apparatuses, and non-transitory computer-readable medium described herein may further include operations, features, means, or instructions for receiving, from the second UE, a system information broadcast key and utilizing the system information broadcast key in the decoding of the first system information transmission.

Some examples of the method, apparatuses, and non-transitory computer-readable medium described herein may further include operations, features, means, or instructions for receiving, from the second UE, signaling triggering the establishing of the relay connection with the second UE and receiving, from the second UE, a confirmation of the first system information transmission over a unicast link secured for exclusive communication between the first UE and the second UE.

Some examples of the method, apparatuses, and non-transitory computer-readable medium described herein may further include operations, features, means, or instructions for receiving, from the second UE, one or more common system information blocks (SIBs) associated with the base station via a logical channel reserved for system information forwarding from the second UE to the first UE.

In some examples of the method, apparatuses, and non-transitory computer-readable medium described herein, the connection state of the first UE may be a connected state. In such examples, the transmitting of the request associated with the base station for the second system information transmission may further include operations, features, means, or instructions for transmitting, to the second UE, a dedicated SIB request associated with the base station for the second system information transmission.

In some examples of the method, apparatuses, and non-transitory computer-readable medium described herein, the connection state of the first UE may be an idle state or an inactive state. In such examples, the transmitting of the request associated with the base station for the second system information transmission may further include operations, features, means, or instructions for transmitting, to the second UE, an indication of a request for a SIB via an RRC sidelink configuration information element.

In some examples of the method, apparatuses, and non-transitory computer-readable medium described herein, the first system information transmission includes an essential SIB (E-SIB) and the second system information transmission comprising on-demand system information.

A method for wireless communication at a second UE is described. The method may include transmitting, to a first UE via broadcast signaling, a first system information transmission including one or more parameters associated with a relay connection with the second UE. The method may further include receiving, from the first UE, a request associated with a base station for a second system information transmission, the request based on the relay connection with the first UE and a connection state of the first UE, the relay connection based on the one or more parameters in the first system information transmission. The method may additionally include transmitting, to the first UE, the second system information transmission in response to the request.

An apparatus for wireless communication at a second UE is described. The apparatus may include a processor and memory coupled to the processor. The processor and memory may be configured to transmit, to a first UE via broadcast signaling, a first system information transmission including one or more parameters associated with a relay connection with the second UE. The processor and memory may be further configured to receive, from the first UE, a request associated with a base station for a second system information transmission, the request based on the relay connection with the first UE and a connection state of the first UE, the relay connection based on the one or more parameters in the first system information transmission. The processor and memory may be further configured to transmit, to the first UE, the second system information transmission in response to the request.

Another apparatus for wireless communication at a second UE is described. The apparatus may include means for transmitting, to a first UE via broadcast signaling, a first system information transmission including one or more parameters associated with a relay connection with the second UE. The apparatus may further include means for receiving, from the first UE, a request associated with a base station for a second system information transmission, the request based on the relay connection with the first UE and a connection state of the first UE, the relay connection based on the one or more parameters in the first system information transmission. The apparatus may additionally include means for transmitting, to the first UE, the second system information transmission in response to the request.

A non-transitory computer-readable medium storing code for wireless communication at a second UE is described. The code may include instructions executable by a processor to transmit, to a first UE via broadcast signaling, a first system information transmission including one or more parameters associated with a relay connection with the second UE. The code may include instructions further executable by a processor to receive, from the first UE, a request associated with a base station for a second system information transmission, the request based on the relay connection with the first UE and a connection state of the first UE, the relay connection based on the one or more parameters in the first system information transmission. The code may include instructions further executable by a processor to transmit, to the first UE, the second system information transmission in response to the request.

Some examples of the method, apparatuses, and non-transitory computer-readable medium described herein may further include operations, features, means, or instructions for transmitting, to the first UE, a discovery message including a cell ID associated with the second UE, a PLMN ID associated with the second UE, and access stratum information relating to a selection criteria associated with the second UE.

In some examples of the method, apparatuses, and non-transitory computer-readable medium described herein, the discovery message may include the first system information transmission

In some examples of the method, apparatuses, and non-transitory computer-readable medium described herein, the discovery message may be transmitted via different signaling than the first system information transmission. The method, apparatuses, and non-transitory computer-readable medium may include further operations, features, means, or instructions for transmitting, to the first UE, a configuration of a periodicity of the first system information transmission, the transmitting of the first system information transmission being based on the configuration of the periodicity of the first system information transmission.

Some examples of the method, apparatuses, and non-transitory computer-readable medium described herein may further include operations, features, means, or instructions for receiving, from the base station, one or more SIBs and generating the first system information transmission at the second UE based on the one or more SIBs, the transmitting of the first system information transmission being based on the generating of the first system information transmission at the second UE.

Some examples of the method, apparatuses, and non-transitory computer-readable medium described herein may further include operations, features, means, or instructions for receiving, from the base station via broadcast signaling, the first system information transmission, the transmitting of the first system information transmission being based on the receiving of the first system information transmission from the base station via the broadcast signaling.

Some examples of the method, apparatuses, and non-transitory computer-readable medium described herein may further include operations, features, means, or instructions for encoding the first system information transmission based on one or more ciphering and integrity protection algorithms.

Some examples of the method, apparatuses, and non-transitory computer-readable medium described herein may further include operations, features, means, or instructions for utilizing a group key in the encoding of the first system information transmission and transmitting, to one or more UEs including the first UE, the group key.

Some examples of the method, apparatuses, and non-transitory computer-readable medium described herein may further include operations, features, means, or instructions for utilizing a system information broadcast key in the encoding of the first system information transmission and transmitting, to the first UE, the system information broadcast key.

Some examples of the method, apparatuses, and non-transitory computer-readable medium described herein may further include operations, features, means, or instructions for transmitting, to the first UE, signaling triggering the establishing of the relay connection with the second UE and transmitting, to the first UE, a confirmation of the first system information transmission over a unicast link secured for exclusive communication between the first UE and the second UE.

In some examples of the method, apparatuses, and non-transitory computer-readable medium described herein, the connection state of the first UE may be a connected state. In such examples of the method, apparatuses, and non-transitory computer-readable medium described herein, the receiving of the request associated with the base station for the second system information transmission may further include operations, features, means, or instructions for receiving, from the first UE, a dedicated SIB request associated with the base station for the second system information transmission. In some examples, the method, apparatuses, and non-transitory computer-readable medium described herein may further include operations, features, means, or instructions for transmitting, to the base station, the dedicated SIB request and receiving, from the base station, the second system information transmission in response to the dedicated system information block request. In such examples of the method, apparatuses, and non-transitory computer-readable medium described herein, the transmitting of the second system information transmission to the first UE being based on the receiving of the second system information transmission from the base station.

In some examples of the method, apparatuses, and non-transitory computer-readable medium described herein, the connection state of the first UE being an idle state or an inactive state. In such examples of the method, apparatuses, and non-transitory computer-readable medium described herein, the receiving of the request associated with the base station for the second system information transmission may further include operations, features, means, or instructions for receiving, from the first UE, an indication of a request for an SIB via an RRC sidelink configuration information element. The method, apparatuses, and non-transitory computer-readable medium described herein may further include operations, features, means, or instructions for performing an on-demand SIB acquisition procedure with the base station based on the receiving of the indication of the request for the SIB. In such examples of the method, apparatuses, and non-transitory computer-readable medium described herein, the transmitting of the second system information transmission to the first UE being based on the performing of the on-demand SIB acquisition procedure with the base station.

In some examples of the method, apparatuses, and non-transitory computer-readable medium described herein, the first system information transmission includes an E-SIB and the second system information transmission includes on-demand system information.

### BRIEF DESCRIPTION OF THE DRAWINGS

FIGS. 1 and 2 illustrate examples of wireless communications systems that support techniques for relaying system information over a sidelink in accordance with one or more aspects of the present disclosure.

FIG. 3 illustrates an example of a layer 3 (L3) relay option that supports techniques for relaying system information over a sidelink in accordance with one or more aspects of the present disclosure.

FIG. 4 illustrates an example of a layer 2 (L2) relay option that supports techniques for relaying system information over a sidelink in accordance with one or more aspects of the present disclosure.

FIG. 5 illustrates an example of a PDCP data packet data unit (PDU) format that supports techniques for relaying system information over a sidelink in accordance with one or more aspects of the present disclosure.

FIGS. 6 and 7 illustrate examples of process flows that support techniques for relaying system information over a sidelink in accordance with one or more aspects of the present disclosure.

FIGS. 8 and 9 show block diagrams of devices that support techniques for relaying system information over a sidelink in accordance with one or more aspects of the present disclosure.

FIG. 10 shows a block diagram of a communications manager that supports techniques for relaying system information over a sidelink in accordance with one or more aspects of the present disclosure.

FIG. 11 shows a diagram of a system including a device that supports techniques for relaying system information over a sidelink in accordance with one or more aspects of the present disclosure.

FIGS. 12 through 19 show flowcharts illustrating methods that support techniques for relaying system information over a sidelink in accordance with one or more aspects of the present disclosure.

### DETAILED DESCRIPTION

In some wireless communications systems, a first UE may be out-of-coverage from a base station and, to facilitate communication with the base station, the first UE may establish a communication link with a second UE that is in-coverage of the base station. For example, the first UE may communicate with the second UE over a sidelink or relay link, such as a PC5 link, and the second UE may communicate with the base station over an access link, such as a Uu link. As such, the second UE may forward or relay signaling from the base station to the first UE or from the first UE to the base station. The second UE may perform L3 relaying or L2 relaying and, in some aspects, may relay information relating to relay selection (or re-selection) criterion or discovery procedures. For example, the second UE may provide, to the first UE, system information including one or more parameters associated with selecting and establishing a relay connection with the second UE (which may be referred to herein as an essential SIB, or E-SIB) or a discovery message (as part of a discovery procedure between the first UE and the second UE). In some cases, upon establishment of the relay connection between the first UE and the second UE, the second UE may additionally forward paging messages or system information updates to the first UE.

The first UE and the second UE, however, may be unaware of how to transmit the E-SIB (e.g., the signaling that the second UE may use to transmit the E-SIB, the security protection the second UE may provide for the E-SIB, or how the signaling for transmitting the E-SIB may change in L3 relaying vs. L2 relaying). Further, the first UE may be unaware of how to obtain on-demand system information, how to receive system information updates from the second UE, or whether to continue to monitor for the E-SIB after establishing the relay connection with the second UE.

Accordingly, some implementations of the present disclosure provide techniques that the first UE and the second UE may employ for transmitting or receiving the E-SIB, transmitting or receiving signaling relating to on-demand system information, and transmitting or receiving system information updates before and after establishing the relay connection between the first UE and the second UE. For instance, in some examples, the second UE may include the E-SIB within the discovery message such that the second UE may transmit both the discovery message and the E-SIB simultaneously (via same signaling, for example, the discovery message may include the E-SIB). In some other examples, the second UE may transmit the E-SIB via different signaling from the discovery message, such as via followed or separate broadcast signaling. Further, the described techniques may be employed at the first UE such that the first UE may transmit, to the second UE, signaling requesting on-demand system information based on a connection state (such as an RRC connection state) of the first UE.

For example, the first UE may transmit the request for the on-demand system information via different signaling or via different information elements based on the connection state of the first UE. Additionally or alternatively, the second UE may forward system information updates to the first UE based on encapsulating system information updates received from the base station in a PC5-RRC message and, in some aspects, transmitting the encapsulated system information updates to the first UE via a PC5 logical channel reserved for system information forwarding.

Particular aspects of the subject matter described in this disclosure can be implemented to realize one or more of the following potential advantages. For example, the described techniques may be implemented to define one or more signaling exchanges to support efficient and complete forwarding of system information to the second UE that is out-of-coverage of the base station and to define one or more signaling exchanges to support efficient acquisition of on-demand system information at the second UE. As such, the first UE may obtain more complete and relevant system information despite being out-of-coverage of the base station, which may increase system connectivity and provide greater coverage for the first UE. Further, the described techniques may be implemented to provide security protection for the E-SIB, which may lower the likelihood that the first UE receives E-SIBs from a “fake” relay and likewise enable the establishment of relay connections according to shorter timelines. Based on experiencing greater connectivity, greater coverage, and establishing relay connections according to shorter timelines, the first UE and the second UE may experience higher data rates, increased throughput, and greater spectral efficiency, among other benefits.

Aspects of the disclosure are initially described in the context of wireless communications systems. Additionally, aspects of the disclosure are illustrated by and described with reference to relaying options, a PDCP data PDU format, and process flows. Aspects of the disclosure are further illustrated by and described with reference to apparatus diagrams, system diagrams, and flowcharts that relate to techniques for relaying system information over a sidelink.

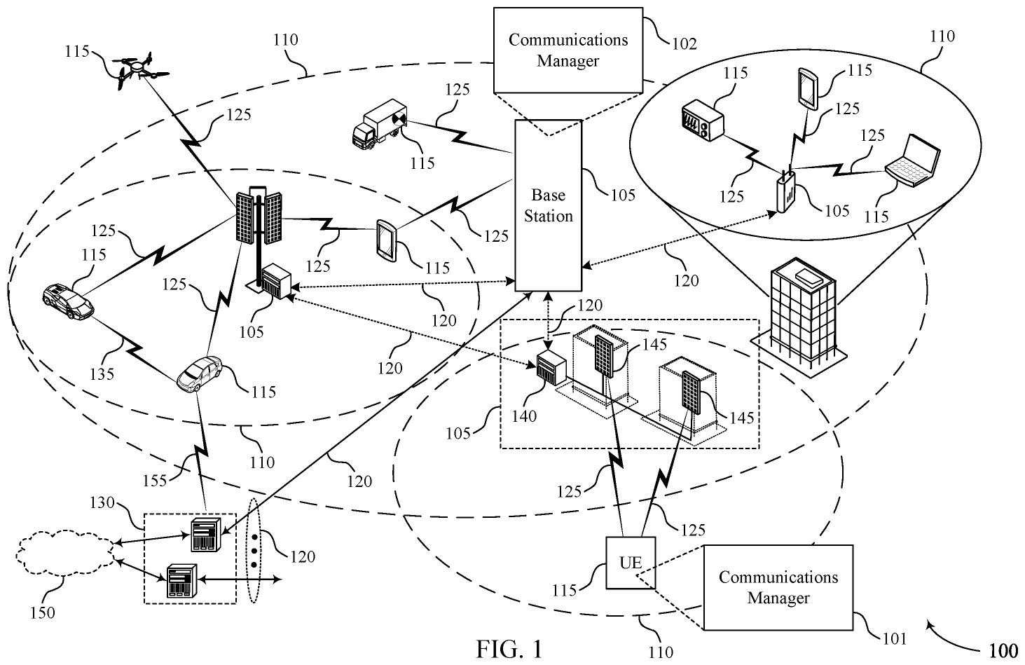

FIG. 1 illustrates an example of a wireless communications system 100 that supports techniques for relaying system information over a sidelink in accordance with one or more aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, be misaligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, sometimes in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (which may be referred to as mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for determining or identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support sidelink communications between UEs 115 such that a first UE 115 that is out-of-coverage of a base station 105 may communicate with (e.g., transmit or receive signaling to or from) the base station 105 via a second UE 115 that is in-coverage of the base station 105. In some examples, the first UE 115, which may be referred to herein as a remote UE 115, may search for a relay UE 115 with which to connect to establish an indirect communication link to the base station 105. To inform the first UE 115 of its availability as a relay UE 115, the second UE 115 may broadcast a discovery message including one or more identifiers of the second UE 115 and selection criteria associated with the second UE 115. Additionally, in some examples, the second UE 115 may transmit system information including one or more parameters associated with establishing a relay connection with the second UE 115 or the base station 105, or both. In some aspects, such system information may be referred to as an E-SIB and may include a minimum amount of system information to establish a connection between the first UE 115 and the base station 105 through the second UE 115.

In some implementations, the second UE 115 may transmit the E-SIB in the discovery message. In some other implementations, the second UE 115 may transmit the E-SIB and the discovery message using different signaling. In some examples, the first UE 115 may receive the discovery message and the E-SIB from the second UE 115 and may establish a connection with the second UE 115 to facilitate communication between the first UE 115 and the second UE 115. Upon establishing the connection with the second UE 115, the first UE 115 may monitor for system information updates forwarded from the second UE 115 or may transmit a request for system information (such as on-demand system information) to the second UE 115. In some implementations, the first UE 115 may transmit the request for on-demand system information via different signaling or different information elements based on a connection state of the first UE 115. For example, the first UE 115 may transmit the request for the on-demand system information via different information elements, which may trigger different acquisition procedures between the second UE 115 and the base station 105, based on whether the first UE 115 is in a connected state, an idle state, or an inactive state.

In various examples, a communications manager 101 or a communications manager 102 may be included in a device to support signaling exchanges for transmitting or receiving system information, which may be associated with specific configurations or operations for relaying system information over a sidelink. For example, a UE 115 may include a communications manager 101 or a base station 105 may include a communications manager 102.

In some examples, a communications manager 101 of the first UE 115 may receive, from the second UE 115 via broadcast signaling, a first system information transmission (e.g., an E-SIB) including one or more parameters associated with a relay connection with the second UE 115. The communications manager 101 may establish the relay connection with the second UE 115 based on the one or more parameters in the first system information transmission. The communications manager 101 may transmit, to the second UE 115, a request associated with a base station 105 for a second system information transmission (e.g., on-demand system information), and the request may be based on establishing the relay connection and the connection state of the first UE 115. The communications manager 101 may receive, from the second UE 115, the second system information transmission in response to the request.

In some other examples, a communications manager 101 of the second UE 115 may transmit, to the first UE 115 via broadcast signaling, a first system information transmission (e.g., an E-SIB) including one or more parameters associated with a relay connection with the second UE 115. The communications manager 101 may establish the relay connection with the first UE 115 based on the one or more parameters in the first system information transmission. The communications manager 101 may receive, from the first UE 115, a request associated with a base station 105 for a second system information transmission (e.g., on-demand system information), and the request may be based on establishing the relay connection and the connection state of the first UE 115. The communications manager 101 may transmit, to the first UE 115, the second system information transmission in response to the request.

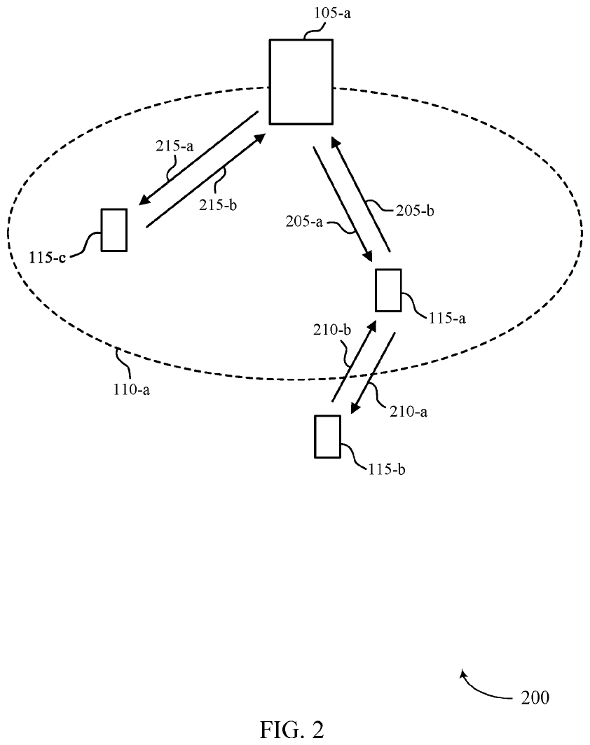

FIG. 2 illustrates an example of a wireless communications system 200 that supports techniques for relaying system information over a sidelink in accordance with one or more aspects of the present disclosure. The wireless communications system 200 may implement or be implemented to realize aspects of the wireless communications system 100. For example, the wireless communications system 200 may include a base station 105-a, a UE 115-a, a UE 115-b, and a UE 115-c, which may be examples of corresponding devices as described herein, including with reference to FIG. 1. In some aspects, the UE 115-a and the UE 115-c may be in-coverage of the base station 105-a (e.g., within a geographic coverage area 110-a of the base station 105-a) and the UE 115-b may be out-of-coverage of the base station 105-a (e.g., outside of the geographic coverage area 110-a of the base station 105-a). In such aspects, the UE 115-b may function as or be an example of a remote UE 115 and may attempt to communicate with the base station 105-a via the UE 115-a, which may function as a relay UE 115.

For example, the UE 115-a and the UE 115-b may be capable of supporting sidelink communications via a communication link 210, which may include a communication link 210-a (e.g., a forward link) from the UE 115-a to the UE 115-b and a communication link 210-b (e.g., a reverse link) from the UE 115-b to the UE 115-a. The UE 115-a may communicate with the base station 105-a via a communication link 205, which may include a downlink communication link 205-a and an uplink communication link 205-b. As such, the UE 115-b may communicate with the base station 105-a via the UE 115-a (e.g., the UE 115-a may function as a relay UE 115). In some examples, such as in examples in which the wireless communications system 200 supports NR communication, the UE 115-a may operate as a single-hop NR sidelink-based relay for the UE 115-b. In other words, the relaying network between the UE 115-b and the base station 105-a may function as a standalone sidelink-based UE-to-network and UE-to-UE relay.

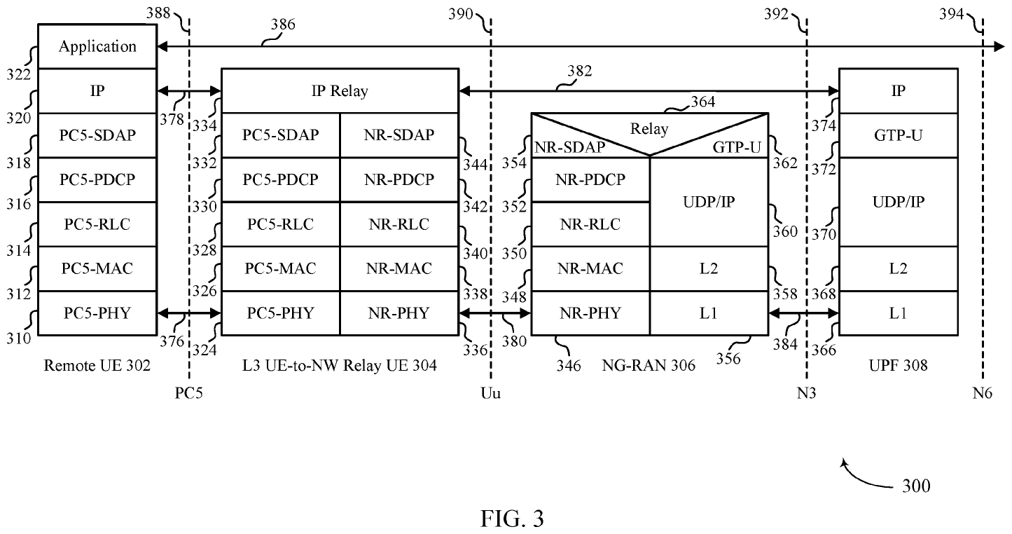

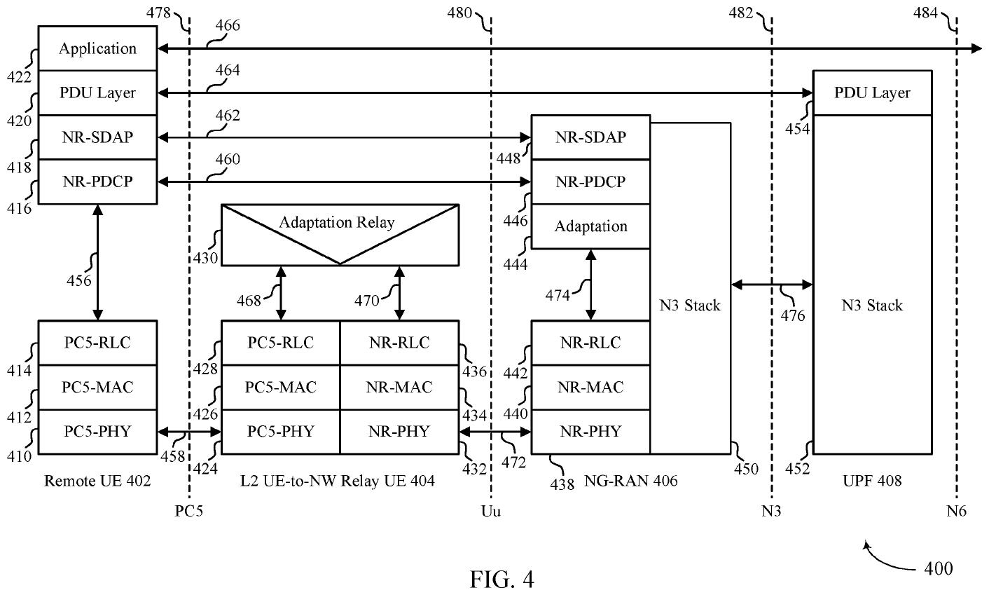

Such a relaying network may implement one or more techniques for providing relay selection (or re-selection) criterion and procedures for link establishment between the UE 115-a and the UE 115-b, authorization of the UE 115-a (the relay UE 115) and the UE 115-b (the remote UE 115), maintenance of quality of service (QoS) for relaying functionality, service continuity, security of relayed connection, and connection management of relayed connection based on one or more user plane protocol stacks and control plane procedures. Further, such a relaying network may also implement one or more techniques for providing upper layer operations of discovery models or procedures for sidelink relaying of communication broadcast by the base station 105-a, such as system information. The relaying network involving the UE 115-a, the UE 115-b, and the base station 105-a may include both L3 relaying and L2 relaying. Additional details relating to L3 relaying are illustrated by and described with reference to FIG. 3 and additional details relating to L2 relaying are illustrated by and described with reference to FIG. 4. In some aspects, L2 relaying may refer to how a UE 115 may relay transmissions from the base station 105-a to another UE 115 via L2 signaling, such as RLC, MAC, PDCP, or service data adaptation protocol (SDAP) signaling. Further, L3 relaying may refer to how a UE 115 may relay transmissions from the base station 105-a to another UE 115 via L3 signaling, such as radio access network (RAN) core network (CN) interfaces.

In examples in which the UE 115-a supports the relaying of system information broadcast by the base station 105-a to the UE 115-b (which may otherwise be unable to receive system information broadcasted from the base station 105-a), the UE 115-a may forward the system information to the UE 115-b via broadcast, groupcast, or dedicated PC5-RRC signaling. For example, if the UE 115-b is out-of-coverage of the base station 105-a (e.g., outside of the geographic coverage area 110-a), the UE 115-b may be unable to monitor Uu paging or Uu SIB broadcasts (due to the coverage limitation). In such examples, the UE 115-a may perform forward-paging for the UE 115-b and forward pages (e.g., relevant pages) to the UE 115-b. In other words, the UE 115-a may monitor a paging occasion of the UE 115-b and may forward any page (or pages) received during that paging occasion to the UE 115-b. In some examples, the UE 115-a may broadcast an E-SIB including system information parameters that may be carried in a master information block (MIB) and a portion of system information parameters that may be carried in a SIB1. Such an E-SIB may include system information parameters associated with establishing a connection with the UE 115-a or the base station 105-a, or both (e.g., the E-SIB may include a minimum amount of system information to enable setup or establishment of a connection). In some aspects, this may be applied to or applicable for an L2 relay (such that the UE 115-a may function as an L2 relay, or both as an L2 relay and an L3 relay, for the UE 115-b).

In some aspects, the UE 115-a may perform different forwarding handlings depending on a purpose of a received paging. For example, if paging is for an emergency service, such as a public warning system (PWS), or for a common SIB update, the UE 115-a may broadcast or groupcast the related PWS or SIB information to the UE 115-b (and any other associated remote UE 115) via PC5 messages. Alternatively, if paging is for a dedicated SIB update, such as SIB12, the UE 115-a may transmit the updated SIB to the UE 115-b with a dedicated PC5-RRC message (such as an RRCReconfigurationSidelink message). In some aspects, such relaying for common SIB or dedicated SIB may be applied to or applicable for both an L2 relay and an L3 relay. As an alternative example, the UE 115-c, which may also function as a remote UE 115 but may be in-coverage of the base station 105-a (e.g., within the geographic coverage area 110-a), may monitor Uu paging or Uu SIB broadcasts from the base station 105-a over a communication link 215 (which may include a downlink communication link 215-a and an uplink communication link 215-b) without assistance from a relay UE 115.

Additionally, in some examples, the UE 115-b may transmit signaling requesting system information (such as an on-demand system information request) to the UE 115-a for any (or all) RRC states of the UE 115-b (such as an idle state, an inactive state, or a connected state). In some cases, however, the UE 115-a and the UE 115-b may be unaware of one or more mechanisms of broadcast, groupcast, or PC5-RRC signaling design, which system information may be relayed to the UE 115-b (or to any remote UEs 115), or one or more mechanisms of an on-demand system information acquisition procedure. Further, the UE 115-a and the UE 115-b may be unaware of one or more signaling mechanisms prior to establishment of the relay connection between the UE 115-a and the UE 115-b and after establishment of the relay connection between the UE 115-a and the UE 115-b.

For example, prior to establishment of the relay connection, the UE 115-a and the UE 115-b may be unaware of whether the E-SIB is included in a discovery message (e.g., a message transmitted by the UE 115-a during a discovery procedure, such as an announcement message) or in a separate message distinct from the discovery message, whether the E-SIB is security protected, whether the E-SIB is the same or different based on whether the UE 115-a is functioning as an L2 relay or an L3 relay, whether the UE 115-b is able to initiate on-demand SIB acquisition, or whether common SIB updates are sent in a PC5 message (or messages) or are directly forwarded from the base station 105-a. After establishment of the relay connection (which may include the transmission of RRC setup signaling from the UE 115-b to the UE 115-a), the UE 115-a and the UE 115-b may be unaware of whether the UE 115-b still continues to monitor for the E-SIB, a procedure for acquisition of on-demand SIB at the UE 115-b, or whether common SIB updates are sent in a PC5 message (or messages) or directly forwarded from the base station 105-a.

Accordingly, some implementations of the present disclosure provide such signaling mechanisms to support the forwarding of system information from the base station 105-a to the UE 115-b both prior to and after establishment of the relay connection between the UE 115-a and the UE 115-b. In some implementations, the UE 115-a may broadcast or groupcast the discovery message and the E-SIB to the UE 115-b prior to the establishment of the relay connection between the UE 115-a and the UE 115-b (as the UE 115-b may use the information provided by the discovery message and the E-SIB to establish the relay connection with the UE 115-a). The UE 115-a may broadcast or groupcast the discovery message for an L2 relay, an L2 light relay, or an L3 relay and the discovery message may include one or more information elements for any of the L2 relay, the L2 light relay, or the L3 relay. For example, the discovery message may include a serving or camping cell ID of the UE 115-a, a PLMN ID of the UE 115-a, and access stratum information on relay selection (or re-selection) criteria, including a load and priority of the UE 115-a. In some aspects, the cell ID of the UE 115-a may be (or may be based on) a physical cell ID (PCI) and a frequency (e.g., a frequency over which the UE 115-a communicates) or may be (or may be based on) a cell global identity (CGI). As referred to herein, an L2 light relay may include an or be an architecture option in L2 relays in which the base station 105-a is unable to manage the PC5 link (e.g., the communication link 210) and UE-controlled mobility is supported.

The UE 115-a may broadcast or groupcast the E-SIB for the L2 relay or the L2 light relay and the E-SIB may include one or more information elements for either or both of the L2 relay or the L2 light relay. For example, the E-SIB may include a MIB, one or more parameters associated with or related to cell access, one or more parameters associated with RRC connection establishment failure controls, one or more cell specific parameters of a serving cell, one or more timers or constants usable by the UE 115-b in various RRC connection states (such as RRC_CONNECTED, RRC_INACTIVE, or RRC_IDLE), or one or more unified access control (UAC) parameters, or a combination thereof. For the L2 relay or the L2 light relay, the E-SIB may be generated in various ways. In some examples, for instance, the UE 115-a may generate the E-SIB based on Uu SIBs. For example, the UE 115-a may receive one or more SIBs from the base station 105-a and may generate the E-SIB based on the one or more SIBs received from the base station 105-a. Alternatively, in some other examples, the base station 105-a may broadcast the E-SIB as (or in) a separate SIB type such that the UE 115-a may receive the E-SIB from the base station 105-a and forward the received E-SIB to the UE 115-b without generating any signaling at the UE 115-a.

The UE 115-a may broadcast or groupcast the E-SIB (or otherwise deliver the E-SIB to the UE 115-b) periodically according to various signaling techniques. In some implementations, for example, the UE 115-a may include the E-SIB in the discovery message as an optional information element. As such, the UE 115-a may transmit the discovery message and the E-SIB via same signaling and simultaneously and the UE 115-b may likewise receive the discovery message and the E-SIB via same signaling. In some other implementations, the UE 115-a may include the E-SIB in a followed groupcast or broadcast discovery message. Such a followed groupcast or broadcast discovery message may include or be an example of additional signaling that carries information related to the discovery message, such as information that is supplementary to the discovery message. For example, the followed groupcast or broadcast discovery message may include or be an example of a discovery additional information message, which may function similarly to a discovery meta message.

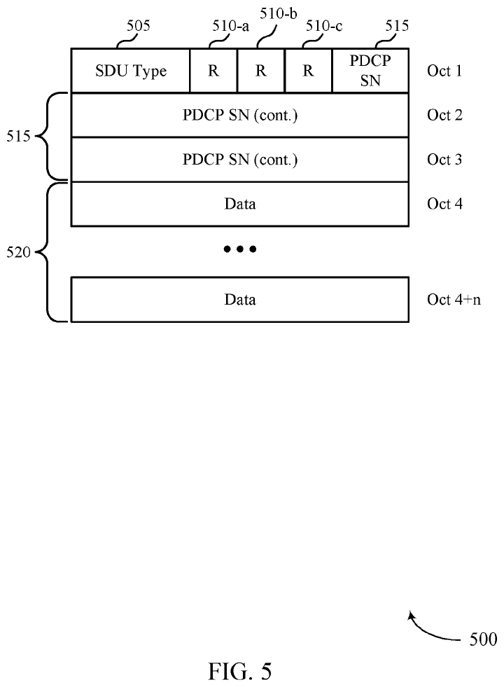

In some other implementations, the UE 115-a may transmit the E-SIB via a separate groupcast or broadcast message different from the discovery message, such as via a PC5 common message. For example, the UE 115-a may transmit the E-SIB to the UE 115-b via a logical channel ID (e.g., a fixed logical channel ID) in a MAC-CE, or via a dedicated L2 destination ID (in a MAC-CE or in SCI, or both) that differentiates the E-SIB from other signaling (e.g., the discovery message). Additionally or alternatively, the UE 115-a may transmit signaling including an indication that the signaling includes the E-SIB to the UE 115-b based on a service data unit (SDU) type in a PDCP data PDU, via a 1-bit indication in a reserved (“R”) field in a PDCP data PDU, or via a PC5 logical channel assigned (or exclusively dedicated for) system information forwarding (in RRC signaling), or a combination thereof. Additional details relating to examples in which the UE 115-a transmits the E-SIB via a PDCP data PDU are described herein, including with reference to FIG. 5. In examples in which the UE 115-a transmits the UE 115-a transmits the E-SIB separately from the discovery message, the UE 115-b may receive a configuration (e.g., from the UE 115-a or the base station 105-a) or be pre-configured with a periodicity of the E-SIB. In some aspects, the UE 115-b may receive such a configuration indicating the periodicity of the E-SIB via RRC signaling.

In some examples, the UE 115-a may security protect the E-SIB via one or more ciphering or integrity protection algorithms. As such, the UE 115-a may protect the UE 115-b from receiving SIB broadcasts from “fake” relays over a different PC5 link, which may result in the establishment of the relay connection between the UE 115-a and the UE 115-b occur according to shorter timelines or otherwise avoid latency associated with decoding SIB broadcasts from non-relevant relays (e.g., relays that may be unable to connect the UE 115-b to the base station 105-a). In some implementations, the UE 115-a may security protect the E-SIB based on encoding the E-SIB based on a group key that is shared among a number of group members based on a provisioning procedure. For example, the UE 115-a may provide the group key to the number of group members during the provisioning procedure such that any one of the number of group members may decode broadcast signaling from the UE 115-a using the group key. In such examples in which the UE 115-a security protects the E-SIB, the UE 115-b may acquire or decode the E-SIB based on (e.g., after) selecting to connect to the UE 115-a (as such selection may involve the reception of one or more security keys usable for decoding the E-SIB).

Additionally or alternatively, the UE 115-a may generate a SIB broadcast/multicast key and may distribute the SIB broadcast/multicast key during or after a PC5 unicast link setup. For example, during or after the PC5 unicast link setup between the UE 115-a and the UE 115-b, the UE 115-a may transmit an indication of the SIB broadcast/multicast key to the UE 115-b such that the UE 115-b may decode broadcast or multicast signaling from the UE 115-b based on the SIB broadcast/multicast key. Additionally or alternatively, the UE 115-a may broadcast or groupcast the E-SIB and, if the E-SIB triggers the UE 115-b to establish the relay connection with the UE 115-a, the UE 115-a may confirm the E-SIB over a secure unicast link between the UE 115-a and the UE 115-b.

The UE 115-b may implement various techniques to acquire (or decode) the E-SIB. In some examples, the UE 115-b may acquire (or decode) the E-SIB after (e.g., immediately after) receiving the discovery message and prior to selecting to establish the relay connection with the UE 115-b. In such examples, the UE 115-b may select to establish the relay connection with the UE 115-a based on both the discovery message and the E-SIB. In some other examples, the UE 115-b may acquire (or decode) the E-SIB from a selected relay UE 115. In other words, in examples in which the UE 115-b selects to establish the relay connection with the UE 115-a, the UE 115-b may acquire or decode the E-SIB transmitted from the UE 115-a and may refrain from acquiring or decoding an E-SIB transmitted by a different UE 115, such as the UE 115-c. In such examples, the UE 115-b may select to establish the relay connection with the UE 115-a based on the discovery message and, after the selecting, the UE 115-b may acquire or decode the E-SIB to obtain the information elements or parameters that the UE 115-b may use to establish the connection with the UE 115-a. Further, in such examples in which the UE 115-b acquires or decodes the E-SIB transmitted from a selected UE 115 (such as the UE 115-a), the selected UE 115 may security protect the E-SIB.

Further, in some implementations, the UE 115-a and the UE 115-b may operate in an unacknowledged mode (UM) for E-SIB delivery and the UE 115-b may refrain from initiating on-demand SIB acquisition prior to establishing the relay connection with the UE 115-a. Upon establishing the relay connection with the UE 115-a, the UE 115-b may continue to monitor for a discovery message for any of the L2 relay, the L2 light relay, or the L3 relay. The UE 115-b, in the L2 relay or the L2 light relay, may be configured to either continue monitoring for the E-SIB or to stop monitoring for the E-SIB. In some aspects, the UE 115-b may receive a configuration (e.g., via RRC signaling) indicating whether the UE 115-b continues to monitor for the E-SIB or stops monitoring for the E-SIB.

The UE 115-a may monitor for system information (e.g., common system information) broadcasted from the base station 105-a and, in some examples, may forward such system information received from the base station 105-a (which may be referred to as Uu SIBs) to the UE 115-b. For example, the UE 115-a may encapsulate one or more Uu SIBs received from the base station 105-a in a PC5-RRC message and the UE 115-a may transmit the encapsulated SIBs to the UE 115-b. In some aspects, which SIBs the UE 115-a encapsulates and forwards to the UE 115-b may be deployment or scenario specific or based on one or more decisions at the UE 115-a. In some examples, the UE 115-a may receive one or more common SIBs from the base station 105-a and may transmit the one or more common SIBs to the UE 115-b via a PC5 logical channel that is reserved or otherwise dedicated for system information forwarding between the UE 115-a and the UE 115-b. In some aspects, the UE 115-a may transmit over such a PC5 logical channel via RRC signaling. Additionally, such common SIBs may include SIBs that include system information parameters or information elements that are common (e.g., relevant or useful) for multiple, if not all, UEs 115 within the wireless communications system 200.

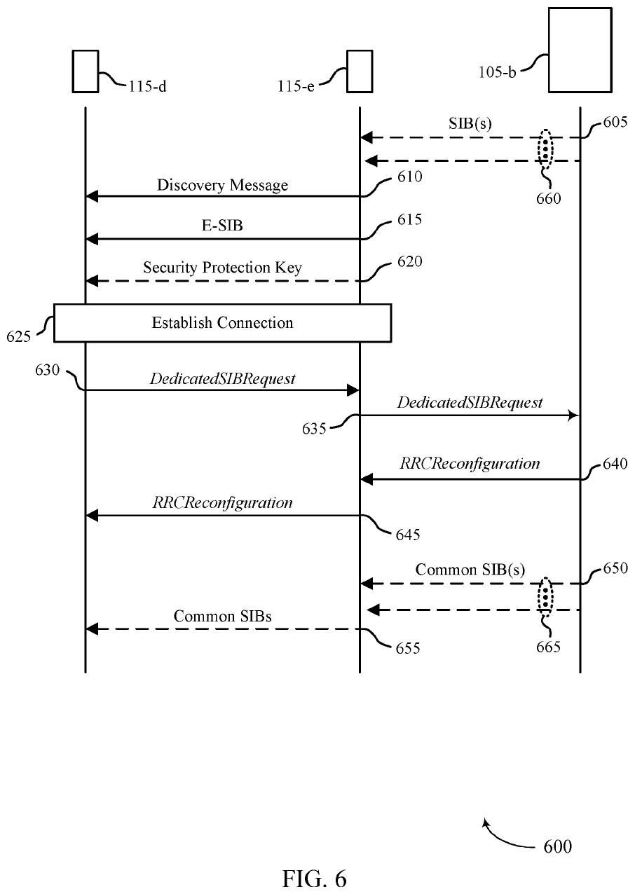

In some examples, the UE 115-b may initiate on-demand SIB acquisition based on (e.g., after) establishing the relay connection with the UE 115-a. In such examples, the UE 115-b may initiate the on-demand SIB acquisition in different RRC states and the signaling mechanism employed by the UE 115-a and the UE 115-b may vary based on the RRC state (e.g., the RRC connection state) of the UE 115-b. For example, if the UE 115-b (or the UE 115-a) is in a connected state, such as an RRC_CONNECTED state, the UE 115-b may transmit a dedicated SIB request associated with the base station 105-a (e.g., the dedicated SIB request may be for a SIB transmitted from the base station 105-a). For instance, the UE 115-b may transmit a DedicatedSIBRequest message to the base station 105-a via the UE 115-a requesting system information from the base station 105-a. The base station 105-a, based on receiving the DedicatedSIBRequest message from the UE 115-b (and via the UE 115-a), may transmit the requested system information (e.g., the requested SIB) via a dedicated RRCReconfiguration message to the UE 115-b via the UE 115-a. Additional details relating to such a signaling mechanism in examples in which the UE 115-b (or the UE 115-a) is in the connected state is illustrated by and described with reference to FIG. 6.

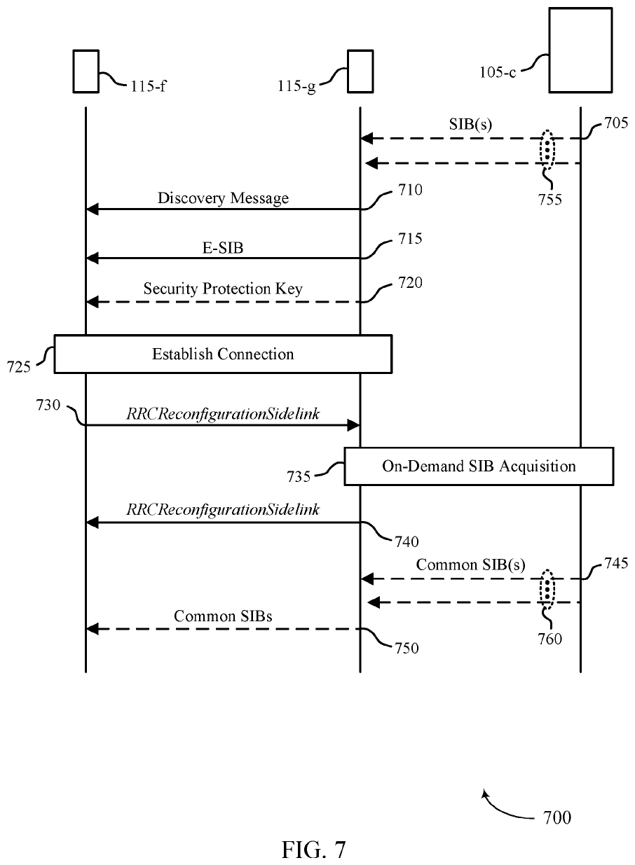

Alternatively, if the UE 115-b (or the UE 115-a) is in an idle state or an inactive state, such as an RRC_IDLE state or an RRC_INACTIVE state, the UE 115-b may transmit an indication of a request for an SIB via an RRC sidelink configuration information element. For instance, the UE 115-b may transmit an indication of requestSIBx in an RRCReconfigurationSidelink message to the UE 115-a for an on-demand SIB (e.g., an on-demand “SIBx”). The UE 115-a, based on receiving the RRCReconfigurationSidelink message from the UE 115-b, may initiate or otherwise trigger an on-demand SIB acquisition procedure between the UE 115-a and the base station 105-a to acquire the requested system information and may transmit the acquired system information to the UE 115-b. Additional details relating to such a signaling mechanism in examples in which the UE 115-b (or the UE 115-a) is in the idle state or the inactive state is illustrated by and described with reference to FIG. 7.

FIG. 3 illustrates an example of an L3 relay option 300 that supports techniques for relaying system information over a sidelink in accordance with one or more aspects of the present disclosure. The L3 relay option 300 may be implemented to realize aspects of the wireless communications system 100 or the wireless communications system 200. For example, the L3 relay option 300 may be a stack protocol-level illustration of a relaying network between a remote UE 302, a relay UE 304 (which may be equivalently referred to as an L3 UE-to-NW relay UE), and a base station 105 (which may include or otherwise interface with a next-generation (NG) RAN (NG-RAN) 315 and a UPF 308). In some examples, the relay UE 304 may forward signaling, such as system information broadcasts, from the NG-RAN 306 or the UPF 308 to the remote UE 302.

In some aspects, the relay UE 304 may be an example of or function as an L3 relay UE, such as an IP router. The relay UE 304 may forward the traffic of the remote UE 302 to the CN using a PDU session of the relay UE 304, where the CN may be an example of a 5GC and may include the functionality of the NG-RAN 306 or the UPF 308, or both. In some examples, the UPF 308 may be perform functionality for packet routing and forwarding as well as for managing external PDU sessions. Further, local routing is possible in the context of the L3 relay option 300. Such local routing may include routing between the remote UE 302 and the relay UE 304 and between the remote UE 302 and another remote UE 302. In some aspects, non-IP traffic may be supported by encapsulation in IP or in a dedicated PDU session per remote UE 302.

As shown in the L3 relay option 300, each of the remote UE 302, the relay UE 304, the NG-RAN 306, and the UPF 308 may feature a protocol stack including various layers of signaling and management. For example, the remote UE 302 may include a PC5-physical (PHY) layer 310, a PC5-MAC layer 312, a PC5-RLC layer 314, a PC5-PDCP layer 316, a PC5-SDAP layer 318, an IP layer 320, and an application layer 322. The relay UE 304, interfacing both a PC5 interface 388 and a Uu interface 390, may include a PC5-PHY layer 324, an NR-PHY layer 336, a PC5-MAC layer 326, an NR-MAC layer 338, a PC5-RLC layer 328, an NR-RLC layer 340, a PC5-PDCP layer 330, an NR-PDCP layer 342, a PC5-SDAP layer 332, an NR-SDAP layer 344, and an IP relay layer 334. The NG-RAN 306, interfacing both the Uu interface 390 and the N3 interface 392, may include an NR-PHY layer 346, a layer 1 (L1) 356, an NR-MAC layer 348, an L2 358, an NR-RLC layer 350, an NR-PDCP layer 352, a user datagram protocol (UDP)/IP layer 360, and a relay layer 364 including an NR-SDAP layer 354 and a general packet radio service (GPRS) tunneling protocol (GTP) user plane (GTP-U) layer 362. The UPF 308, interfacing the N3 interface 392 and an N6 interface 394, may include an L1 366, an L2 368, a UDP/IP layer 370, a GTP-U layer 372, and an IP layer 374. In some aspects, L1 relaying may refer to a relaying of signaling between the network (e.g., the NG-RAN 306 or the UPF 308) and the remote UE 302 via PHY layer signaling and management.

Further, each of the devices or functionalities may communicate with each other via a same layer. For example, the remote UE 302 may communicate with the relay UE 304 via the PC5-PHY layer 310 and an IP layer 320 over the PC5 interface 388 via a link 376 and a link 378, respectively. For further example, the relay UE 304 may communicate with the NG-RAN 306 via the NR-PHY layer 336 over the Uu interface 390 via a link 380 and the NG-RAN 306 may communicate with the UPF 308 via the L1 356 over an N3 interface 392 via a link 384. Additionally, the relay UE 304 may communicate with the UPF 308 via the IP relay layer 334 (e.g., for routing and forwarding operations) over the Uu interface 390 and the N3 interface 392 via a link 382. The remote UE 302 may additionally communicate with higher functionality via the application layer 322 over the N6 interface 394 via a link 386.

FIG. 4 illustrates an example of an L2 relay option 400 that supports techniques for relaying system information over a sidelink in accordance with one or more aspects of the present disclosure. The L2 relay option 400 may be implemented to realize aspects of the wireless communications system 100 or the wireless communications system 200. For example, the L2 relay option 400 may be a stack protocol-level illustration of a relaying network between a remote UE 402, a relay UE 404 (which may be equivalently referred to as an L2 UE-to-NW relay UE), and a base station 105 (which may include or otherwise interface with an NG-RAN 406 and a UPF 408). In some examples, the relay UE 404 may forward signaling, such as system information broadcasts, from the NG-RAN 406 or the UPF 408 to the remote UE 402.

In some aspects, the relay UE 404 may be an example of or function as an L2 relay UE and may perform relaying below a PDCP layer. For example, the relay UE 404 may forward PC5 bearer and Uu bearer using adaptation layer function. In some aspects, the data radio bearers (DRBs) of the remote UE 402 may be controlled by the NG-RAN 406 and traffic (e.g., all traffic) may terminate at the 5GC (which may include the functionality of the NG-RAN 406 or the UPF 408, or both). As such, the L2 relay option 400 may be unable to support direct communication between remote UEs 405 or to the relay UE 404. In some aspects, the L2 relay option 400 may also illustrate an L2 light relay, which may include an or be an architecture option in L2 relays in which the base station 105 is unable to manage the PC5 link and UE-controlled mobility is supported.

As shown in the L2 relay option 400, each of the remote UE 402, the relay UE 404, the NG-RAN 406, and the UPF 408 may feature a protocol stack including various layers of signaling and management. For example, the remote UE 402 may include a PC5-PHY layer 410, a PC5-MAC layer 412, a PC5-RLC layer 414, an NR-PDCP layer 416 (which may interface with one or more lower layers via a link 456), an NR-SDAP layer 418, a PDU layer 420, and an application layer 422. The relay UE 404, interfacing both the PC5 interface 478 and the Uu interface 480, may include a PC5-PHY layer 424, an NR-PHY layer 432, a PC5-MAC layer 426, an NR-MAC layer 434, a PC5-RLC layer 428, an NR-RLC layer 436, and an application relay layer 430 (which may interface with one or more lower layers via a link 468 and a link 470). The NG-RAN 406, interfacing both the Uu interface 480 and the N3 interface 482, may include an NR-PHY layer 438, an NR-MAC layer 440, an NR-RLC layer 442, an adaptation layer 444 (which may interface with one or more lower layers via a link 474), an NR-PDCP layer 446, an NR-SDAP layer 448, and an N3 stack 450. The UPF 408, interfacing the N3 interface 482 and an N6 interface 484, may include an N3 stack 452 and a PDU layer 454.

Further, each of the devices or functionalities may communicate with each other via a same layer. For example, the remote UE 402 may communicate with the relay ULE 404 via the PC5-PHY layer 410 over the PC5 interface 478 via a link 458. For further example, the relay UE 404 may communicate with the NG-RAN 406 via the NR-PHY layer 432 over the Uu interface 480 via a link 472 and the NG-RAN 406 may communicate with the UPF 408 via the N3 stack 450 over the N3 interface 482 via a link 476. Additionally, the relay UE 404 may communicate with the NG-RAN 406 via the NR-PDCP layer 416 and the NR-SDAP layer 418 via a link 460 and a link 462, respectively, and the remote UE 402 may communicate with the UPF 408 via the PDU layer 454 via a link 464. The remote UE 402 may additionally communicate with higher functionality via the application layer 422 over the N6 interface 484 via a link 466.

FIG. 5 illustrates an example of a PDCP data PDU format 500 that supports techniques for relaying system information over a sidelink in accordance with one or more aspects of the present disclosure. The PDCP data PDU format 500 may be implemented to realize aspects of the wireless communications system 100 or the wireless communications system 200. For example, a relay UE 115 may transmit an E-SIB to a remote UE 115 via an SDU type in PDCP or via a 1-bit indication for a reserved (“R”) field in PDCP.

The PDCP data PDU format 500 may include a number (e.g., a number equal to 4+n, where n refers to a number of octets occupied by data 520) of octets and may include various fields for conveying information. For example, the PDCP data PDU format 500 may include an “SDU Type” field 505 indicating an SDU type of the PDCP data PDU format 500. In some implementations, the relay UE 115 may transmit the E-SIB to the remote UE 115 via an SDU type dedicated for transmitting the E-SIB (such that the “SDU Type” field 505 may differentiate the signaling of the E-SIB from signaling carrying a discovery message). The PDCP data PDU format 500 may also include a number of reserved bits 510, shown as “R,” including a reserved bit 510-a, a reserved bit 510-b, and a reserved bit 510-c. In some implementations, the relay UE 115 may set one of the reserved bits 510 to indicate that the PDCP data PDU format 500 carries the E-SIB (such that the set “R” bit 510 differentiates the signaling of the E-SIB from signaling carrying the discovery message).

The PDCP data PDU format 500 may also include a PDCP sequence number (SN) 515, which may span one or multiple octets of the PDCP data PDU format 500. For example, the PDCP SN 515 may span a portion of octet 1 and all of octet 2 and octet 3. Additionally, the PDCP data PDU format 500 may include data 520, which may span one or multiple octets.

FIG. 6 illustrates an example of a process flow 600 that supports techniques for relaying system information over a sidelink in accordance with one or more aspects of the present disclosure. The process flow 600 may implement or be implemented to realize aspects of the wireless communications system 100 or the wireless communications system 200. For example, the process flow 600 may illustrate communications between a UE 115-d (which may function as a remote UE 115), a UE 115-e (which may function as a relay UE 115), and a base station 105-b, which may be examples of corresponding devices described herein, including with reference to FIGS. 1 and 2. In some examples, the UE 115-e may forward system information to the UE 115-d from the base station 105-b according to some of the implementations of the present disclosure.

In the following description of the process flow 600, the operations may be performed (e.g., reported or provided) in a different order than the order shown, or the operations performed by the UE 115-d, the UE 115-e, and the base station 105-b may be performed in different orders or at different times. For example, specific operations may also be left out of the process flow 600, or other operations may be added to the process flow 600. Further, although some operations or signaling may be shown to occur at different times for discussion purposes, these operations may actually occur at the same time. Additionally, although some optional operations are shown with dotted lines, other operations may also be optional without exceeding the scope of the present disclosure.

At 605, the UE 115-e may receive one or more SIBs from the base station 105-b. For example, as illustrated by an ellipse 660, the UE 115-e may receive a set of multiple SIBs from the base station 105-b. In some examples, the base station 105-b may broadcast the SIBs to UEs 115 within a coverage area of the base station 105-b, such that the UE 115-e (which may be in-coverage of the base station 105-b) may receive the SIBs and the UE 115-d (which may be out-of-coverage of the base station 105-b) may be unable to receive the SIBs. In some implementations, the UE 115-e may generate an E-SIB based on the SIBs received from the base station 105-b. In some other implementations, the one or more SIBs received from the base station 105-b may include a SIB type corresponding to the E-SIB, such that the UE 115-e may refrain from generating the E-SIB.

At 610, the UE 115-e may broadcast a discovery message. Likewise, the UE 115-d may receive the discovery message from the UE 115-e. In some examples, the discovery message may include a cell ID associated with the UE 115-e, a PLMN ID associated with the UE 115-e, and access stratum information relating to selection (or re-selection) criterion or procedures associated with the UE 115-e.

At 615, the UE 115-e may broadcast the E-SIB. Likewise, the UE 115-d may receive the E-SIB from the UE 115-e via the broadcast signaling. The E-SIB may include one or more information elements or parameters associated with a relay connection with the UE 115-e (or an access link connection with the base station 105-b). In some implementations, the UE 115-e may transmit the E-SIB and the discovery message via same broadcast signaling (such that the discovery message includes the E-SIB). In some other implementations, the UE 115-e may transmit the discovery message and the E-SIB via different signaling. In such implementations, the UE 115-d may receive the E-SIB according to a configured periodicity that is received from the UE 115-e or the base station 105-b or pre-configured at the UE 115-d. In some examples, the UE 115-d may acquire or decode the E-SIB subsequent to receiving the discovery message and prior to selecting to establish the relay connection with the UE 115-e. In some other examples, the UE 115-d may acquire or decode the E-SIB subsequent to selecting to establish the relay connection with the UE 115-e.

At 620, the UE 115-d may receive a security protection key from the UE 115-e for decoding the E-SIB in examples in which the E-SIB is security protected based on one or more ciphering and integrity protection algorithms. In such examples, the UE 115-d may receive a group key that is shared among one or more UEs 115 or a SIB broadcast key (e.g., a SIB broadcast/multicast key). In some aspects, the UE 115-d may receive the security protection key prior to receiving the E-SIB. In some other aspects, the UE 115-d may receive the security protection key after receiving the E-SIB.

At 625, the UE 115-d and the UE 115-e may establish the relay connection based on the one or more information elements or parameters in the E-SIB and the discovery message. Upon establishing the relay connection, the UE 115-d may transmit a request for on-demand system information to the UE 115-e. The signaling mechanism employed by the UE 115-d and the UE 115-e may be based on a connection state of the UE 115-d (or of the UE 115-e). In the context of the process flow 600, the UE 115-d (or the UE 115-e) may be in a connected state (e.g., an RRC_CONNECTED state).

At 630, the UE 115-d may transmit, to the UE 115-e, a dedicated SIB request associated with the base station 105-b for the on-demand system information (e.g., a second system information transmission). In some aspects, the UE 115-d may transmit such a dedicated SIB request based on transmitting a DedicatedSIBRequest message to the base station 105-b via the UE 115-e.

At 635, the UE 115-e may relay or otherwise forward the dedicated SIB request received from the UE 115-d to the base station 105-b. For example, the UE 115-e may forward the DedicatedSIBRequest message received from the UE 115-d to the base station 105-b.

At 640, the base station 105-b may transmit the requested SIB via a dedicated RRC message, such as an RRCReconfiguration message, to the UE 115-e. In some aspects, the base station 105-b may transmit an indication of the requested SIB to the UE 115-e via a requestedSIB information element in the RRCReconfiguration message.

At 645, the UE 115-e may transmit (e.g., relay or forward) the on-demand SIB received from the base station 105-b to the UE 115-d. As such, the UE 115-d may receive and obtain the requested on-demand system information based on direct signaling forwarding between the UE 115-d and the base station 105-b using the UE 115-e. In some aspects, the UE 115-e may relay or forward the indication of the obtained SIB to the UE 115-d via the requestedSIB information element in the RRCReconfiguration message.

At 650, the base station 105-b may transmit (e.g., broadcast) one or more SIBs, such as common SIBs. For example, as illustrated by an ellipse 665, the base station 105-b may transmit a set of multiple common SIBs. Likewise, the UE 115-e may receive the one or more common SIBs and select to relay (in full or in part) the one or more common SIBs to the UE 115-d.

At 655, the UE 115-e may transmit (e.g., relay or forward) the one or more common SIBs selected by the UE 115-e to the UE 115-d. In some examples, the UE 115-e may transmit the common SIBs via a logical channel reserved for system information forwarding between the UE 115-e and the UE 115-d.

FIG. 7 illustrates an example of a process flow 700 that supports techniques for relaying system information over a sidelink in accordance with one or more aspects of the present disclosure. The process flow 700 may implement or be implemented to realize aspects of the wireless communications system 100 or the wireless communications system 200. For example, the process flow 700 may illustrate communications between a UE 115-f (which may function as a remote UE 115), a UE 115-g (which may function as a relay UE 115), and a base station 105-c, which may be examples of corresponding devices described herein, including with reference to FIGS. 1 and 2. In some examples, the UE 115-g may forward system information to the UE 115-f from the base station 105-c according to some of the implementations of the present disclosure.

In the following description of the process flow 700, the operations may be performed (e.g., reported or provided) in a different order than the order shown, or the operations performed by the UE 115-f, the UE 115-g, and the base station 105-c may be performed in different orders or at different times. For example, specific operations may also be left out of the process flow 700, or other operations may be added to the process flow 700. Further, although some operations or signaling may be shown to occur at different times for discussion purposes, these operations may actually occur at the same time. Additionally, although some optional steps are shown with dotted lines, other steps may also be optional without exceeding the scope of the present disclosure.

At 705, the UE 115-g may receive one or more SIBs from the base station 105-c. For example, as illustrated by an ellipse 755, the UE 115-g may receive a set of multiple SIBs from the base station 105-c. In some examples, the base station 105-c may broadcast the SIBs to UEs 115 within a coverage area of the base station 105-c, such that the UE 115-g (which may be in-coverage of the base station 105-c) may receive the SIBs and the UE 115-f (which may be out-of-coverage of the base station 105-c) may be unable to receive the SIBs. In some implementations, the UE 115-g may generate an E-SIB based on the SIBs received from the base station 105-c. In some other implementations, the one or more SIBs received from the base station 105-c may include a SIB type corresponding to the E-SIB, such that the UE 115-g may refrain from generating the E-SIB.

At 710, the UE 115-g may broadcast a discovery message. Likewise, the UE 115-f may receive the discovery message from the UE 115-g. In some examples, the discovery message may include a cell ID associated with the UE 115-g, a PLMN ID associated with the UE 115-g, and access stratum information relating to selection (or re-selection) criterion or procedures associated with the UE 115-g.

At 715, the UE 115-g may broadcast the E-SIB. Likewise, the UE 115-f may receive the E-SIB from the UE 115-g via the broadcast signaling. The E-SIB may include one or more information elements or parameters associated with a relay connection with the UE 115-g (or an access link connection with the base station 105-c). In some implementations, the UE 115-g may transmit the E-SIB and the discovery message via same broadcast signaling (such that the discovery message includes the E-SIB). In some other implementations, the UE 115-g may transmit the discovery message and the E-SIB via different signaling. In such implementations, the UE 115-f may receive the E-SIB according to a configured periodicity that is received from the UE 115-g or the base station 105-c or pre-configured at the UE 115-f In some examples, the UE 115-f may acquire or decode the E-SIB subsequent to receiving the discovery message and prior to selecting to establish the relay connection with the UE 115-g. In some other examples, the UE 115-f may acquire or decode the E-SIB subsequent to selecting to establish the relay connection with the UE 115-g.

At 720, the UE 115-f may receive a security protection key from the UE 115-g for decoding the E-SIB in examples in which the E-SIB is security protected based on one or more ciphering and integrity protection algorithms. In such examples, the UE 115-f may receive a group key that is shared among one or more UEs 115 or a SIB broadcast key (e.g., a SIB broadcast/multicast key). In some aspects, the UE 115-f may receive the security protection key prior to receiving the E-SIB. In some other aspects, the UE 115-f may receive the security protection key after receiving the E-SIB.

At 725, the UE 115-f and the UE 115-g may establish the relay connection based on the one or more information elements or parameters in the E-SIB and the discovery message. Upon establishing the relay connection, the UE 115-f may transmit a request for on-demand system information to the UE 115-g. The signaling mechanism employed by the UE 115-f and the UE 115-g may be based on a connection state of the UE 115-f (or of the UE 115-g). In the context of the process flow 700, the UE 115-f (or the UE 115-g) may be in an idle state or an inactive state (e.g., an RRC_IDLE state or an RRC_INACTIVE state).

At 730, the UE 115-f may transmit, to the UE 115-g, an indication of a request for a SIB (e.g., an on-demand SIB) via an RRC sidelink configuration information element. In some aspects, the UE 115-f may transmit such a request based on transmitting an indication of a requestSIBx in an RRCReconfigurationSidelink message for the requested on-demand SIB.

At 735, the UE 115-g may trigger and perform an on-demand SIB acquisition procedure with the base station 105-c based on receiving the request for the on-demand SIB from the UE 115-f at 730. The UE 115-g, based on performing the on-demand SIB acquisition procedure with the base station 105-c, may acquire the requested on-demand SIB from the base station 105-c.

At 740, the UE 115-g may encapsulate the acquired SIB and may transmit the acquired SIB to the UE 115-f. In some examples, the UE 115-g may transmit the acquired SIB to the UE 115-f via a PC5-RRC message (such as a dedicated PC5-RRC message). Additionally or alternatively, the UE 115-g may transmit the acquired SIB to the UE 115-f via a PC5 logical channel reserved for system information forwarding between the UE 115-f and the UE 115-g. In some aspects, the UE 115-g may transmit an indication of the acquired SIB via a dedicatedSIB information element in a RRCReconfigurationSidelink message.

At 745, the base station 105-c may transmit (e.g., broadcast) one or more SIBs, such as common SIBs. For example, as illustrated by an ellipse 760, the base station 105-c may transmit a set of multiple common SIBs. Likewise, the UE 115-g may receive the one or more common SIBs and select to relay (in full or in part) the one or more common SIBs to the UE 115-f.

At 750, the UE 115-g may transmit (e.g., relay or forward) the one or more common SIBs selected by the UE 115-g to the UE 115-f. In some examples, the UE 115-g may transmit the common SIBs via a logical channel reserved for system information forwarding between the UE 115-f and the UE 115-g.

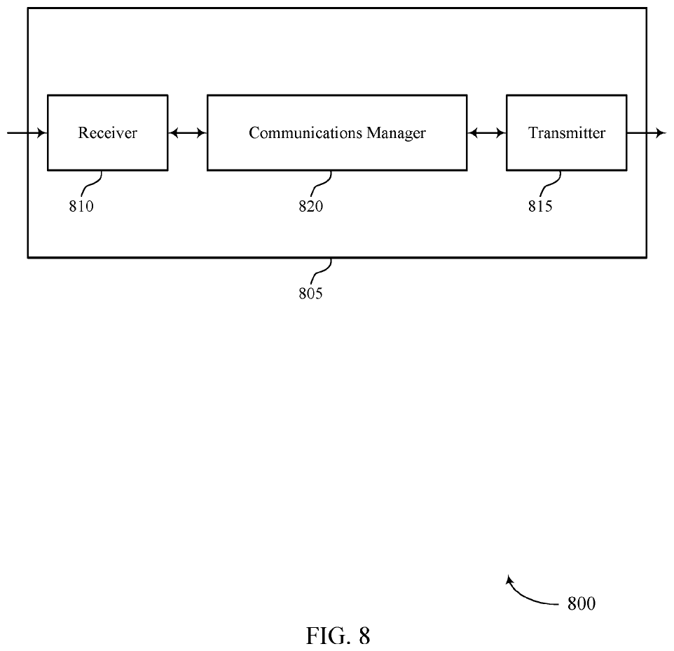

FIG. 8 shows a block diagram 800 of a device 805 that supports techniques for relaying system information over a sidelink in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for relaying system information over a sidelink). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for relaying system information over a sidelink). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for relaying system information over a sidelink as described herein. For example, the communications manager 820, the receiver 810, the transmitter 815, or various combinations or components thereof may support a method for performing one or more of the functions described herein.

In some examples, the communications manager 820 may be an example means for performing various aspects of system information relaying over a sidelink as described herein. The communications manager 820 (or its sub-components), the receiver 810, the transmitter 815, or various combinations or components thereof may be implemented in hardware (e.g., in communications management circuitry). The hardware or circuitry may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, the communications manager 820 (or its sub-components), the receiver 810, the transmitter 815, or various combinations or components thereof may be implemented in code (e.g., as communications management software or firmware) executed by a processor. If implemented in code executed by a processor, the functions of the communications manager 820 (or its sub-components), the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. For example, the communications manager 820 may be configured as or otherwise support a means for receiving, from a second UE via broadcast signaling, a first system information transmission including one or more parameters associated with a relay connection with the second UE. The communications manager 820 may be configured as or otherwise support a means for transmitting, to the second UE, a request associated with a base station for a second system information transmission, the request based on the relay connection with the second UE and a connection state of the first UE, the relay connection based on the one or more parameters in the first system information transmission. The communications manager 820 may be configured as or otherwise support a means for receiving, from the second UE, the second system information transmission in response to the request.

Additionally or alternatively, the communications manager 820 may support wireless communication at a second UE in accordance with examples as disclosed herein. For example, the communications manager 820 may be configured as or otherwise support a means for transmitting, to a first UE via broadcast signaling, a first system information transmission including one or more parameters associated with a relay connection with the second UE. The communications manager 820 may be configured as or otherwise support a means for receiving, from the first UE, a request associated with a base station for a second system information transmission, the request based on the relay connection with the first UE and a connection state of the first UE, the relay connection based on the one or more parameters in the first system information transmission. The communications manager 820 may be configured as or otherwise support a means for transmitting, to the first UE, the second system information transmission in response to the request.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced processing, reduced power consumption, and more efficient utilization of communication resources.

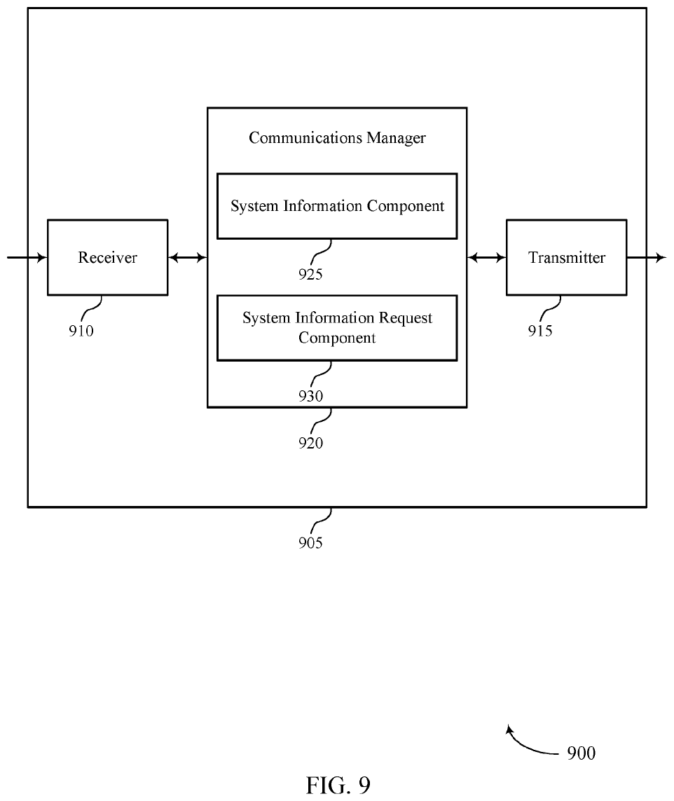

FIG. 9 shows a block diagram 900 of a device 905 that supports techniques for relaying system information over a sidelink in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for relaying system information over a sidelink). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for relaying system information over a sidelink). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for relaying system information over a sidelink as described herein. For example, the communications manager 920 may include a system information component 925 a system information request component 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first UE in accordance with examples as disclosed herein. The system information component 925 may be configured as or otherwise support a means for receiving, from a second UE via broadcast signaling, a first system information transmission including one or more parameters associated with a relay connection with the second UE. The system information request component 930 may be configured as or otherwise support a means for transmitting, to the second UE, a request associated with a base station for a second system information transmission, the request based on the relay connection with the second UE and a connection state of the first UE, the relay connection based on the one or more parameters in the first system information transmission. The system information component 925 may be configured as or otherwise support a means for receiving, from the second UE, the second system information transmission in response to the request.

Additionally or alternatively, the communications manager 920 may support wireless communication at a second UE in accordance with examples as disclosed herein. The system information component 925 may be configured as or otherwise support a means for transmitting, to a first UE via broadcast signaling, a first system information transmission including one or more parameters associated with a relay connection with the second UE. The system information request component 930 may be configured as or otherwise support a means for receiving, from the first UE, a request associated with a base station for a second system information transmission, the request based on the relay connection with the first UE and a connection state of the first UE, the relay connection based on the one or more parameters in the first system information transmission. The system information component 925 may be configured as or otherwise support a means for transmitting, to the first UE, the second system information transmission in response to the request.

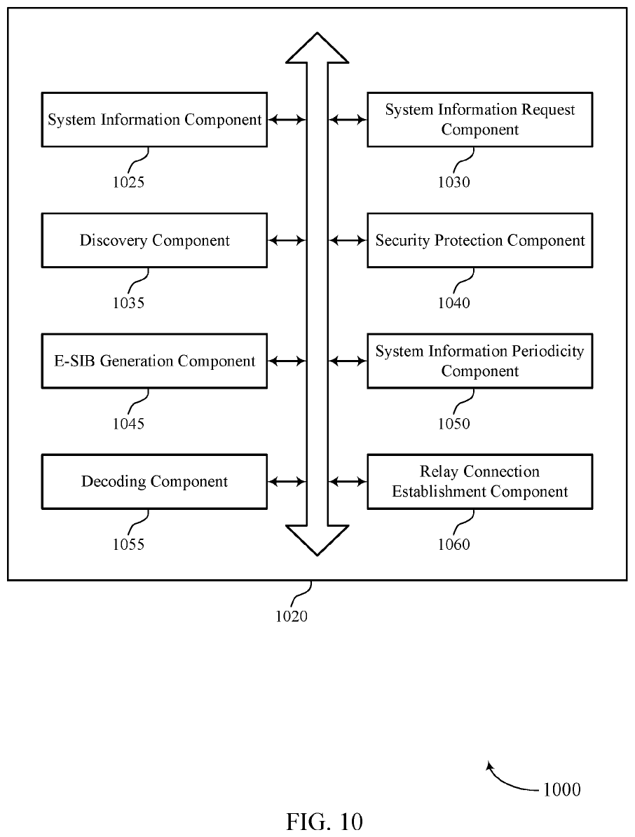

FIG. 10 shows a block diagram 1000 of a communications manager 1020 that supports techniques for relaying system information over a sidelink in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for relaying system information over a sidelink as described herein. For example, the communications manager 1020 may include a system information component 1025, a system information request component 1030, a discovery component 1035, a security protection component 1040, a E-SIB generation component 1045, a system information periodicity component 1050, a decoding component 1055, a relay connection establishment component 1060, or any combination thereof. Each of these components may communicate, directly or indirectly, with one another (e.g., via one or more buses).

The communications manager 1020 may support wireless communication at a first UE in accordance with examples as disclosed herein. The system information component 1025 may be configured as or otherwise support a means for receiving, from a second UE via broadcast signaling, a first system information transmission including one or more parameters associated with a relay connection with the second UE. The system information request component 1030 may be configured as or otherwise support a means for transmitting, to the second UE, a request associated with a base station for a second system information transmission, the request based on the relay connection with the second UE and a connection state of the first UE, the relay connection based on the one or more parameters in the first system information transmission. In some examples, the system information component 1025 may be configured as or otherwise support a means for receiving, from the second UE, the second system information transmission in response to the request.

In some examples, the discovery component 1035 may be configured as or otherwise support a means for receiving, from the second UE, a discovery message including a cell ID associated with the second UE, a PLMN ID associated with the second UE, and access stratum information relating to a selection criteria associated with the second UE. In some examples, the discovery message may be received via a MAC-CE, SCI, PDCP signaling, RRC signaling, or any combination thereof. In some examples, the discovery message may include the first system information transmission.

In some examples, the discovery message may be received via different signaling than the first system information transmission and the system information periodicity component 1050 may be configured as or otherwise support a means for receiving, from the second UE, a configuration of a periodicity of the first system information transmission, the receiving of the first system information transmission being based on the configuration of the periodicity of the first system information transmission.

In some examples, the decoding component 1055 may be configured as or otherwise support a means for decoding the first system information transmission subsequent to receiving the discovery message and prior the relay connection (e.g., prior to establishing or selecting to establish the relay connection) with the second UE. In some examples, the relay connection establishment component 1060 may be configured as or otherwise support a means for selecting to establish the relay connection with the second UE based on the discovery message. In some examples, the decoding component 1055 may be configured as or otherwise support a means for decoding the first system information transmission based on establishing the relay connection with the second UE.

In some examples, the security protection component 1040 may be configured as or otherwise support a means for decoding the first system information transmission based on one or more ciphering and integrity protection algorithms. In some examples, the security protection component 1040 may be configured as or otherwise support a means for receiving, from the second UE, a group key, the group key shared among one or more UEs including the first UE. In some examples, the security protection component 1040 may be configured as or otherwise support a means for utilizing the group key in the decoding of the first system information transmission.

In some examples, the security protection component 1040 may be configured as or otherwise support a means for receiving, from the second UE, a system information broadcast key. In some examples, the security protection component 1040 may be configured as or otherwise support a means for utilizing the system information broadcast key in the decoding of the first system information transmission. In some examples, the security protection component 1040 may be configured as or otherwise support a means for receiving, from the second UE, signaling triggering the establishing of the relay connection with the second UE. In some examples, the security protection component 1040 may be configured as or otherwise support a means for receiving, from the second UE, a confirmation of the first system information transmission over a unicast link secured for exclusive communication between the first UE and the second UE.

In some examples, the system information component 1025 may be configured as or otherwise support a means for receiving, from the second UE, one or more common SIBs associated with the base station via a logical channel reserved for system information forwarding from the second UE to the first UE.

In some examples, the system information request component 1030 may be configured as or otherwise support a means for transmitting, to the second UE, a dedicated SIB request associated with the base station for the second system information transmission. In some examples, the system information request component 1030 may be configured as or otherwise support a means for transmitting, to the second UE, an indication of a request for an SIB via an RRC sidelink configuration information element. In some examples, the first system information transmission may include an E-SIB and the second system information transmission may include on-demand system information.

Additionally or alternatively, the communications manager 1020 may support wireless communication at a second UE in accordance with examples as disclosed herein. In some examples, the system information component 1025 may be configured as or otherwise support a means for transmitting, to a first UE via broadcast signaling, a first system information transmission including one or more parameters associated with a relay connection with the second UE. In some examples, the system information request component 1030 may be configured as or otherwise support a means for receiving, from the first UE, a request associated with a base station for a second system information transmission, the request based on the relay connection with the first UE and a connection state of the first UE, the relay connection based on the one or more parameters in the first system information transmission. In some examples, the system information component 1025 may be configured as or otherwise support a means for transmitting, to the first UE, the second system information transmission in response to the request.

In some examples, the discovery component 1035 may be configured as or otherwise support a means for transmitting, to the first UE, a discovery message including a cell ID associated with the second UE, a PLMN ID associated with the second UE, and access stratum information relating to a selection criteria associated with the second UE. In some examples, the discovery message may be transmitted via a MAC-CE, SCI, PDCP signaling, RRC signaling, or any combination thereof. In some examples, the discovery message may include the first system information transmission.

In some examples, the discovery message may be transmitted via different signaling than the first system information transmission and the system information periodicity component 1050 may be configured as or otherwise support a means for transmitting, to the first UE, a configuration of a periodicity of the first system information transmission, the transmitting of the first system information transmission being based on the configuration of the periodicity of the first system information transmission.

In some examples, the system information component 1025 may be configured as or otherwise support a means for receiving, from the base station, one or more SIBs. In some examples, the E-SIB generation component 1045 may be configured as or otherwise support a means for generating the first system information transmission at the second UE based on the one or more SIBs, the transmitting of the first system information transmission being based on the generating of the first system information transmission at the second UE.

In some examples, the system information component 1025 may be configured as or otherwise support a means for receiving, from the base station via broadcast signaling, the first system information transmission, the transmitting of the first system information transmission being based on the receiving of the first system information transmission from the base station via the broadcast signaling.

In some examples, the security protection component 1040 may be configured as or otherwise support a means for encoding the first system information transmission based on one or more ciphering and integrity protection algorithms. In some examples, the security protection component 1040 may be configured as or otherwise support a means for utilizing a group key in the encoding of the first system information transmission. In some examples, the security protection component 1040 may be configured as or otherwise support a means for transmitting, to one or more UEs including the first UE, the group key.

In some examples, the security protection component 1040 may be configured as or otherwise support a means for utilizing a system information broadcast key in the encoding of the first system information transmission. In some examples, the security protection component 1040 may be configured as or otherwise support a means for transmitting, to the first UE, the system information broadcast key. In some examples, the security protection component 1040 may be configured as or otherwise support a means for transmitting, to the first UE, signaling triggering the establishing of the relay connection with the second UE. In some examples, the security protection component 1040 may be configured as or otherwise support a means for transmitting, to the first UE, a confirmation of the first system information transmission over a unicast link secured for exclusive communication between the first UE and the second UE.

In some examples, the system information request component 1030 may be configured as or otherwise support a means for receiving, from the first UE, a dedicated SIB request associated with the base station for the second system information transmission, the method further including transmitting, to the base station, the dedicated SIB request and receiving, from the base station, the second system information transmission in response to the dedicated SIB request. In some examples, the transmitting of the second system information transmission to the first UE may be based on the receiving of the second system information transmission from the base station.

In some examples, the system information request component 1030 may be configured as or otherwise support a means for transmitting, to the base station, the dedicated SIB request and the system information component 1025 may be configured as or otherwise support a means for receiving, from the base station, the second system information transmission in response to the dedicated SIB request, the transmitting of the second system information transmission to the first UE being based on the receiving of the second system information transmission from the base station.

In some examples, the system information request component 1030 may be configured as or otherwise support a means for receiving, from the first UE, an indication of a request for a SIB via an RRC sidelink configuration information element, the method further including performing an on-demand SIB acquisition procedure with the base station based on the receiving of the indication of the request for the SIB, the transmitting of the second system information transmission to the first UE being based on the performing of the on-demand SIB acquisition procedure with the base station.

In some examples, the system information request component 1030 may be configured as or otherwise support a means for performing an on-demand SIB acquisition procedure with the base station based on the receiving of the indication of the request for the SIB, the transmitting of the second system information transmission to the first UE being based on the performing of the on-demand SIB acquisition procedure with the base station. In some examples, the first system information transmission may include an E-SIB and the second system information transmission may include on-demand system information.

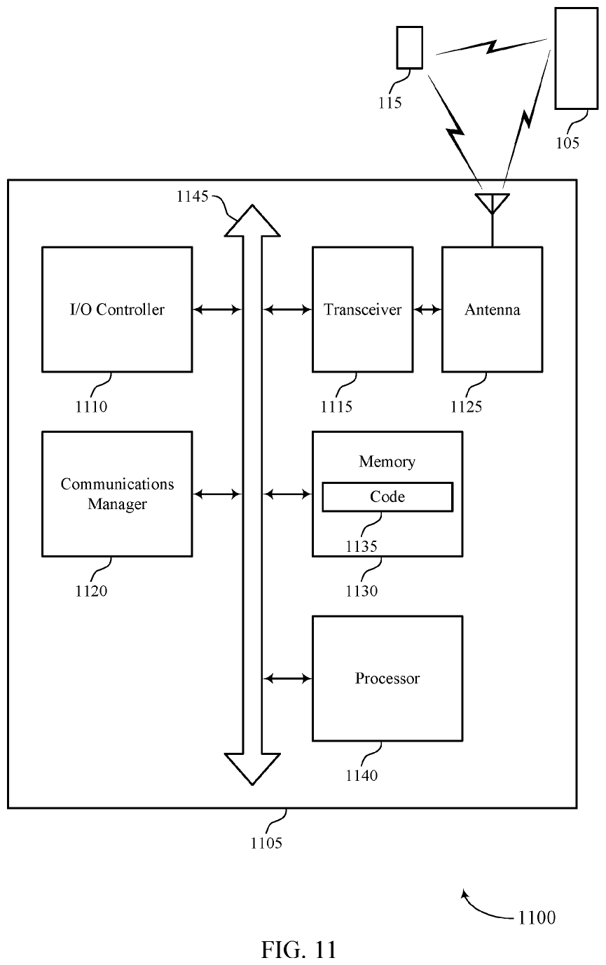

FIG. 11 shows a diagram of a system 1100 including a device 1105 that supports techniques for relaying system information over a sidelink in accordance with one or more aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for relaying system information over a sidelink). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a first UE in accordance with examples as disclosed herein. For example, the communications manager 1120 may be configured as or otherwise support a means for receiving, from a second UE via broadcast signaling, a first system information transmission including one or more parameters associated with a relay connection with the second UE. The communications manager 1120 may be configured as or otherwise support a means for transmitting, to the second UE, a request associated with a base station for a second system information transmission, the request based on the relay connection with the second UE and a connection state of the first UE, the relay connection based on the one or more parameters in the first system information transmission. The communications manager 1120 may be configured as or otherwise support a means for receiving, from the second UE, the second system information transmission in response to the request.

Additionally or alternatively, the communications manager 1120 may support wireless communication at a second UE in accordance with examples as disclosed herein. For example, the communications manager 1120 may be configured as or otherwise support a means for transmitting, to a first UE via broadcast signaling, a first system information transmission including one or more parameters associated with a relay connection with the second UE. The communications manager 1120 may be configured as or otherwise support a means for receiving, from the first UE, a request associated with a base station for a second system information transmission, the request based on the relay connection with the first UE and a connection state of the first UE, the relay connection based on the one or more parameters in the first system information transmission. The communications manager 1120 may be configured as or otherwise support a means for transmitting, to the first UE, the second system information transmission in response to the request.

By including or configuring the communications manager 1120 in accordance with examples as described herein, the device 1105 may support techniques for improved communication reliability, reduced latency, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for relaying system information over a sidelink as described herein, or the processor 1140 and the memory 1130 may be otherwise configured to perform or support such operations.

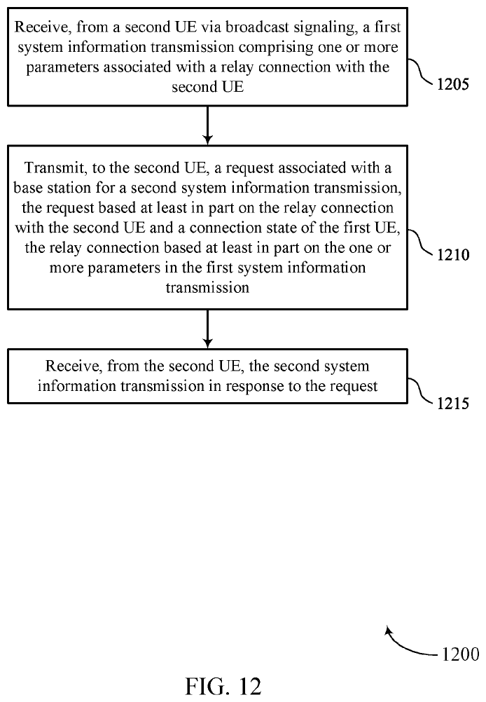

FIG. 12 shows a flowchart illustrating a method 1200 that supports techniques for relaying system information over a sidelink in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include receiving, from a second UE via broadcast signaling, a first system information transmission including one or more parameters associated with a relay connection with the second UE. The operations of 1205 may be performed in accordance with examples as disclosed herein. In some examples, aspects of the operations of 1205 may be performed by a system information component 1025 as described with reference to FIG. 10.

At 1210, the method may include transmitting, to the second UE, a request associated with a base station for a second system information transmission, the request based on the relay connection with the second UE and a connection state of the first UE, the relay connection based on the one or more parameters in the first system information transmission. The operations of 1210 may be performed in accordance with examples as disclosed herein. In some examples, aspects of the operations of 1210 may be performed by a system information request component 1030 as described with reference to FIG. 10.

At 1215, the method may include receiving, from the second UE, the second system information transmission in response to the request. The operations of 1215 may be performed in accordance with examples as disclosed herein. In some examples, aspects of the operations of 1215 may be performed by a system information component 1025 as described with reference to FIG. 10.

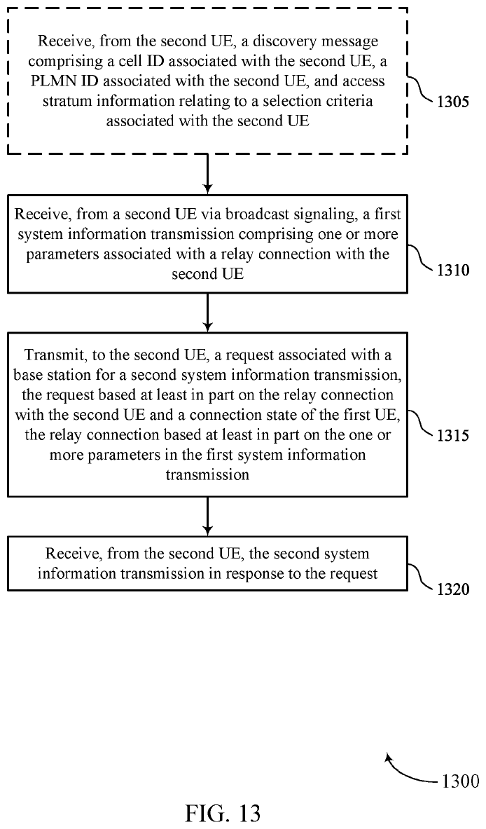

FIG. 13 shows a flowchart illustrating a method 1300 that supports techniques for relaying system information over a sidelink in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include receiving, from the second UE, a discovery message including a cell ID associated with the second UE, a PLMN ID associated with the second UE, and access stratum information relating to a selection criteria associated with the second UE. The operations of 1305 may be performed in accordance with examples as disclosed herein. In some examples, aspects of the operations of 1305 may be performed by a discovery component 1035 as described with reference to FIG. 10.

At 1310, the method may include receiving, from a second UE via broadcast signaling, a first system information transmission including one or more parameters associated with a relay connection with the second UE. The operations of 1310 may be performed in accordance with examples as disclosed herein. In some examples, aspects of the operations of 1310 may be performed by a system information component 1025 as described with reference to FIG. 10.

At 1315, the method may include transmitting, to the second UE, a request associated with a base station for a second system information transmission, the request based on the relay connection with the second UE and a connection state of the first UE, the relay connection based on the one or more parameters in the first system information transmission. The operations of 1315 may be performed in accordance with examples as disclosed herein. In some examples, aspects of the operations of 1315 may be performed by a system information request component 1030 as described with reference to FIG. 10.

At 1320, the method may include receiving, from the second UE, the second system information transmission in response to the request. The operations of 1320 may be performed in accordance with examples as disclosed herein. In some examples, aspects of the operations of 1320 may be performed by a system information component 1025 as described with reference to FIG. 10.

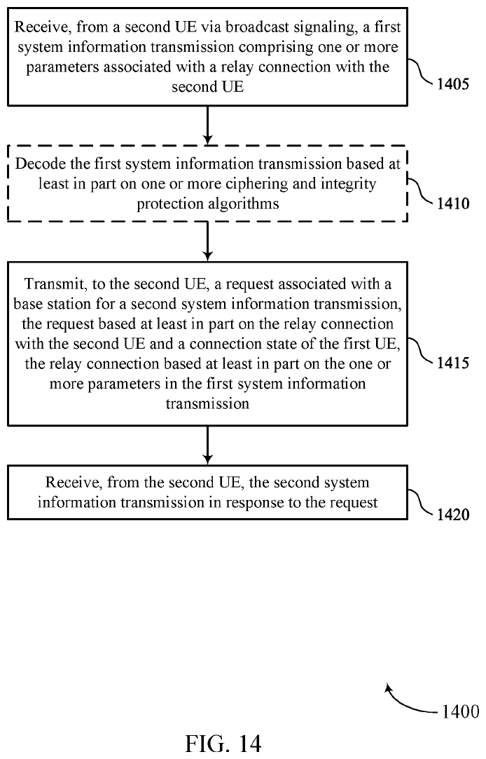

FIG. 14 shows a flowchart illustrating a method 1400 that supports techniques for relaying system information over a sidelink in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include receiving, from a second UE via broadcast signaling, a first system information transmission including one or more parameters associated with a relay connection with the second UE. The operations of 1405 may be performed in accordance with examples as disclosed herein. In some examples, aspects of the operations of 1405 may be performed by a system information component 1025 as described with reference to FIG. 10.

At 1410, the method may include decoding the first system information transmission based on one or more ciphering and integrity protection algorithms. The operations of 1410 may be performed in accordance with examples as disclosed herein. In some examples, aspects of the operations of 1410 may be performed by a security protection component 1040 as described with reference to FIG. 10.

At 1415, the method may include transmitting, to the second UE, a request associated with a base station for a second system information transmission, the request based on the relay connection with the second UE and a connection state of the first UE, the relay connection based on the one or more parameters in the first system information transmission. The operations of 1415 may be performed in accordance with examples as disclosed herein. In some examples, aspects of the operations of 1415 may be performed by a system information request component 1030 as described with reference to FIG. 10.

At 1420, the method may include receiving, from the second UE, the second system information transmission in response to the request. The operations of 1420 may be performed in accordance with examples as disclosed herein. In some examples, aspects of the operations of 1420 may be performed by a system information component 1025 as described with reference to FIG. 10.

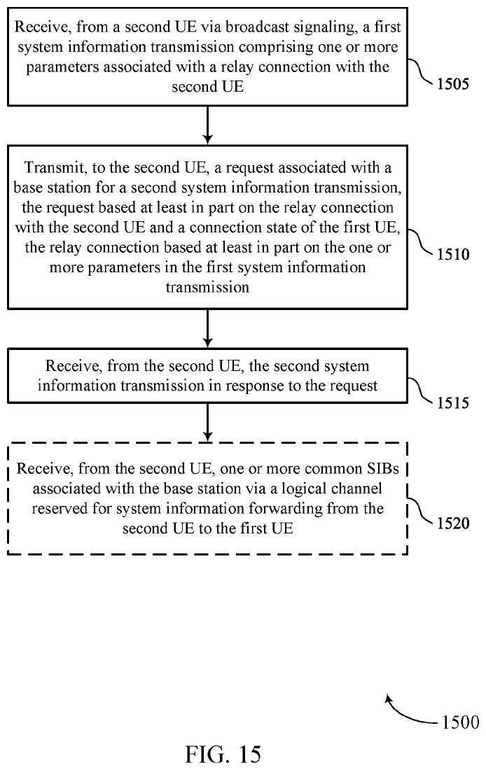

FIG. 15 shows a flowchart illustrating a method 1500 that supports techniques for relaying system information over a sidelink in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include receiving, from a second UE via broadcast signaling, a first system information transmission including one or more parameters associated with a relay connection with the second UE. The operations of 1505 may be performed in accordance with examples as disclosed herein. In some examples, aspects of the operations of 1505 may be performed by a system information component 1025 as described with reference to FIG. 10.

At 1510, the method may include transmitting, to the second UE, a request associated with a base station for a second system information transmission, the request based on the relay connection with the second UE and a connection state of the first UE, the relay connection based on the one or more parameters in the first system information transmission. The operations of 1510 may be performed in accordance with examples as disclosed herein. In some examples, aspects of the operations of 1510 may be performed by a system information request component 1030 as described with reference to FIG. 10.

At 1515, the method may include receiving, from the second UE, the second system information transmission in response to the request. The operations of 1515 may be performed in accordance with examples as disclosed herein. In some examples, aspects of the operations of 1515 may be performed by a system information component 1025 as described with reference to FIG. 10.

At 1520, the method may include receiving, from the second UE, one or more common SIBs associated with the base station via a logical channel reserved for system information forwarding from the second UE to the first UE. The operations of 1520 may be performed in accordance with examples as disclosed herein. In some examples, aspects of the operations of 1520 may be performed by a system information component 1025 as described with reference to FIG. 10.

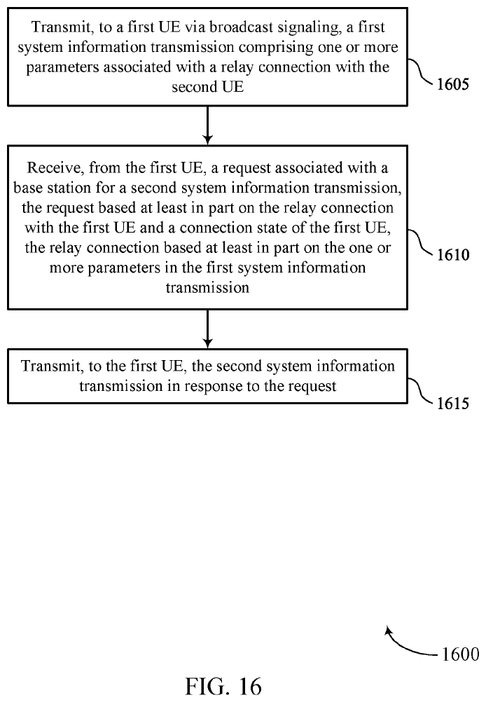

FIG. 16 shows a flowchart illustrating a method 1600 that supports techniques for relaying system information over a sidelink in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include transmitting, to a first UE via broadcast signaling, a first system information transmission including one or more parameters associated with a relay connection with the second UE. The operations of 1605 may be performed in accordance with examples as disclosed herein. In some examples, aspects of the operations of 1605 may be performed by a system information component 1025 as described with reference to FIG. 10.

At 1610, the method may include receiving, from the first UE, a request associated with a base station for a second system information transmission, the request based on the relay connection with the first UE and a connection state of the first UE, the relay connection based on the one or more parameters in the first system information transmission. The operations of 1610 may be performed in accordance with examples as disclosed herein. In some examples, aspects of the operations of 1610 may be performed by a system information request component 1030 as described with reference to FIG. 10.

At 1615, the method may include transmitting, to the first UE, the second system information transmission in response to the request. The operations of 1615 may be performed in accordance with examples as disclosed herein. In some examples, aspects of the operations of 1615 may be performed by a system information component 1025 as described with reference to FIG. 10.

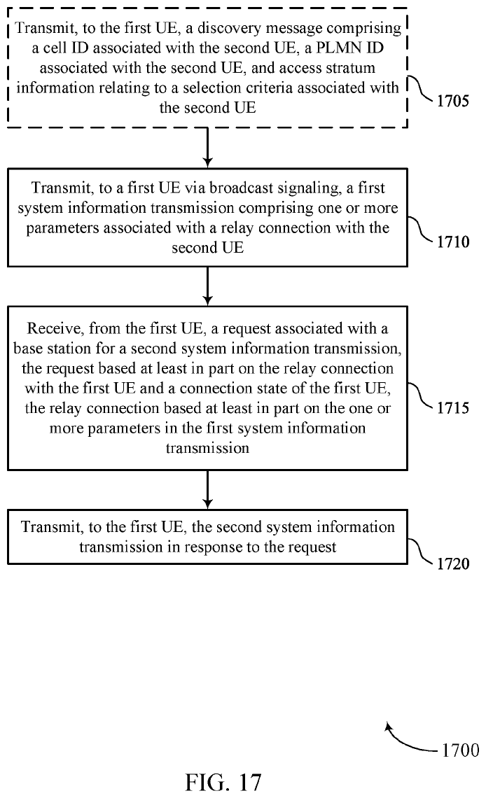

FIG. 17 shows a flowchart illustrating a method 1700 that supports techniques for relaying system information over a sidelink in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include transmitting, to the first UE, a discovery message including a cell ID associated with the second UE, a PLMN ID associated with the second UE, and access stratum information relating to a selection criteria associated with the second UE. The operations of 1705 may be performed in accordance with examples as disclosed herein. In some examples, aspects of the operations of 1705 may be performed by a discovery component 1035 as described with reference to FIG. 10.

At 1710, the method may include transmitting, to a first UE via broadcast signaling, a first system information transmission including one or more parameters associated with a relay connection with the second UE. The operations of 1710 may be performed in accordance with examples as disclosed herein. In some examples, aspects of the operations of 1710 may be performed by a system information component 1025 as described with reference to FIG. 10.

At 1715, the method may include receiving, from the first UE, a request associated with a base station for a second system information transmission, the request based on the relay connection with the first UE and a connection state of the first UE, the relay connection based on the one or more parameters in the first system information transmission. The operations of 1715 may be performed in accordance with examples as disclosed herein. In some examples, aspects of the operations of 1715 may be performed by a system information request component 1030 as described with reference to FIG. 10.

At 1720, the method may include transmitting, to the first UE, the second system information transmission in response to the request. The operations of 1720 may be performed in accordance with examples as disclosed herein. In some examples, aspects of the operations of 1720 may be performed by a system information component 1025 as described with reference to FIG. 10.

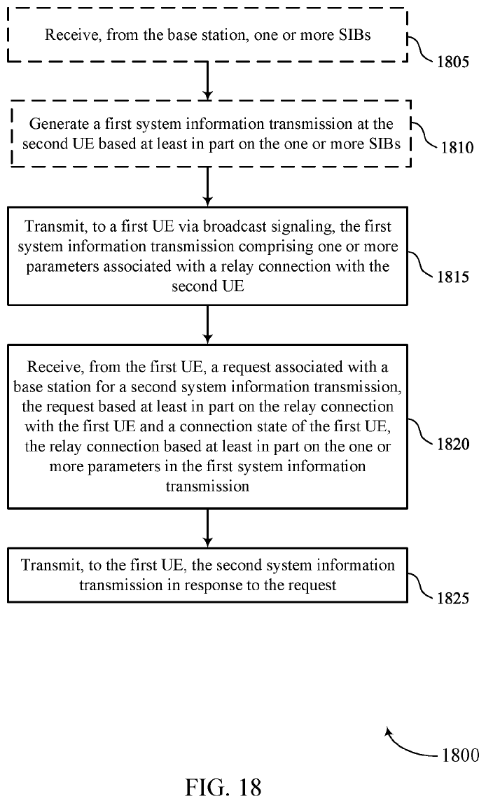

FIG. 18 shows a flowchart illustrating a method 1800 that supports techniques for relaying system information over a sidelink in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include receiving, from the base station, one or more SIBs. The operations of 1805 may be performed in accordance with examples as disclosed herein. In some examples, aspects of the operations of 1805 may be performed by a system information component 1025 as described with reference to FIG. 10.

At 1810, the method may include generating a first system information transmission at the second UE based on the one or more SIBs. The operations of 1810 may be performed in accordance with examples as disclosed herein. In some examples, aspects of the operations of 1810 may be performed by a E-SIB generation component 1045 as described with reference to FIG. 10.

At 1815, the method may include transmitting, to a first UE via broadcast signaling, the first system information transmission including one or more parameters associated with a relay connection with the second UE. The operations of 1815 may be performed in accordance with examples as disclosed herein. In some examples, aspects of the operations of 1815 may be performed by a system information component 1025 as described with reference to FIG. 10.

At 1820, the method may include receiving, from the first UE, a request associated with a base station for a second system information transmission, the request based on the relay connection with the first UE and a connection state of the first UE, the relay connection based on the one or more parameters in the first system information transmission. The operations of 1820 may be performed in accordance with examples as disclosed herein. In some examples, aspects of the operations of 1820 may be performed by a system information request component 1030 as described with reference to FIG. 10.

At 1825, the method may include transmitting, to the first UE, the second system information transmission in response to the request. The operations of 1825 may be performed in accordance with examples as disclosed herein. In some examples, aspects of the operations of 1825 may be performed by a system information component 1025 as described with reference to FIG. 10.

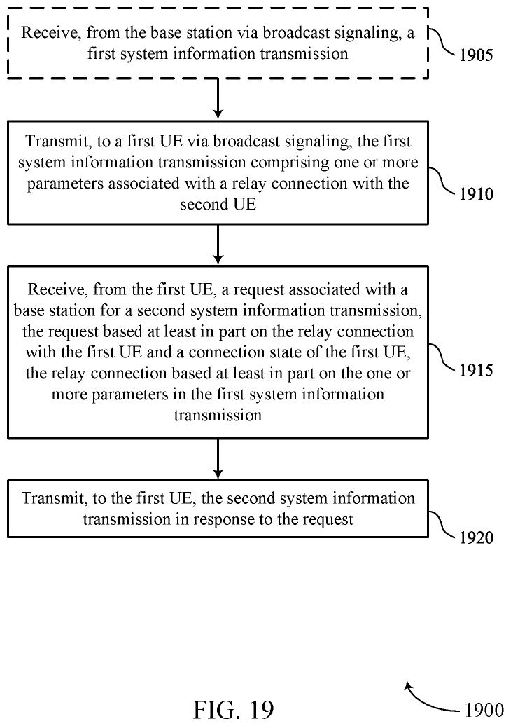

FIG. 19 shows a flowchart illustrating a method 1900 that supports techniques for relaying system information over a sidelink in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1905, the method may include receiving, from the base station via broadcast signaling, a first system information transmission. The operations of 1905 may be performed in accordance with examples as disclosed herein. In some examples, aspects of the operations of 1905 may be performed by a system information component 1025 as described with reference to FIG. 10.

At 1910, the method may include transmitting, to a first UE via broadcast signaling, the first system information transmission including one or more parameters associated with a relay connection with the second UE. The operations of 1910 may be performed in accordance with examples as disclosed herein. In some examples, aspects of the operations of 1910 may be performed by a system information component 1025 as described with reference to FIG. 10.

At 1915, the method may include receiving, from the first UE, a request associated with a base station for a second system information transmission, the request based on the relay connection with the first UE and a connection state of the first UE, the relay connection based on the one or more parameters in the first system information transmission. The operations of 1915 may be performed in accordance with examples as disclosed herein. In some examples, aspects of the operations of 1915 may be performed by a system information request component 1030 as described with reference to FIG. 10.

At 1920, the method may include transmitting, to the first UE, the second system information transmission in response to the request. The operations of 1920 may be performed in accordance with examples as disclosed herein. In some examples, aspects of the operations of 1920 may be performed by a system information component 1025 as described with reference to FIG. 10.

The following provides an overview of aspects of the present disclosure:
Aspect 1: A method for wireless communication at a first UE, comprising: receiving, from a second UE via broadcast signaling, a first system information transmission comprising one or more parameters associated with a relay connection with the second UE; transmitting, to the second UE, a request associated with a base station for a second system information transmission, the request based at least in part on the relay connection with the second UE and a connection state of the first UE, the relay connection based at least in part on the one or more parameters in the first system information transmission; and receiving, from the second UE, the second system information transmission in response to the request.
Aspect 2: The method of aspect 1, further comprising: receiving, from the second UE, a discovery message comprising a cell ID associated with the second UE, a PLMN ID associated with the second UE, and access stratum information relating to a selection criteria associated with the second UE.
Aspect 3: The method of aspect 2, the discovery message comprising the first system information transmission.
Aspect 4: The method of aspect 2, the discovery message being received via different signaling than the first system information transmission, the method further comprising: receiving, from the second UE, a configuration of a periodicity of the first system information transmission, the receiving of the first system information transmission being based at least in part on the configuration of the periodicity of the first system information transmission.
Aspect 5: The method of aspect 4, the first system information transmission being received via a MAC-CE, SCI, PDCP signaling, RRC signaling, or any combination thereof.
Aspect 6: The method of any of aspects 2, 4, or 5, further comprising: decoding the first system information transmission subsequent to receiving the discovery message and prior to establishing the relay connection with the second UE.
Aspect 7: The method of any of aspects 2, 4, or 5, further comprising: selecting to establish the relay connection with the second UE based at least in part on the discovery message; and decoding the first system information transmission based at least in part on establishing the relay connection with the second UE.
Aspect 8: The method of any of aspects 1 through 7, further comprising: decoding the first system information transmission based at least in part on one or more ciphering and integrity protection algorithms.
Aspect 9: The method of aspect 8, further comprising: receiving, from the second UE, a group key, the group key shared among one or more UEs including the first UE; and utilizing the group key in the decoding of the first system information transmission.
Aspect 10: The method of any of aspects 8 through 9, further comprising: receiving, from the second UE, a system information broadcast key; and utilizing the system information broadcast key in the decoding of the first system information transmission.
Aspect 11: The method of any of aspects 8 through 10, further comprising: receiving, from the second UE, signaling triggering the establishing of the relay connection with the second UE; and receiving, from the second UE, a confirmation of the first system information transmission over a unicast link secured for exclusive communication between the first UE and the second UE.
Aspect 12: The method of any of aspects 1 through 11, further comprising: receiving, from the second UE, one or more common SIBs associated with the base station via a logical channel reserved for system information forwarding from the second UE to the first UE.
Aspect 13: The method of any of aspects 1 through 12, the connection state of the first UE being a connected state, and the transmitting of the request associated with the base station for the second system information transmission comprising: transmitting, to the second UE, a dedicated SIB request associated with the base station for the second system information transmission.
Aspect 14: The method of any of aspects 1 through 12, the connection state of the first UE being an idle state or an inactive state, and the transmitting of the request associated with the base station for the second system information transmission comprising: transmitting, to the second UE, an indication of a request for a SIB via an RRC control sidelink configuration information element.
Aspect 15: The method of any of aspects 1 through 14, the first system information transmission comprising an E-SIB and the second system information transmission comprising on-demand system information.
Aspect 16: A method for wireless communication at a second UE, comprising: transmitting, to a first UE via broadcast signaling, a first system information transmission comprising one or more parameters associated with a relay connection with the second UE; receiving, from the first UE, a request associated with a base station for a second system information transmission, the request based at least in part on the relay connection with the first UE and a connection state of the first UE, the relay connection based at least in part on the one or more parameters in the first system information transmission; and transmitting, to the first UE, the second system information transmission in response to the request.
Aspect 17: The method of aspect 16, further comprising: transmitting, to the first UE, a discovery message comprising a cell identifier associated with the second UE, a public land mobile network identifier associated with the second UE, and access stratum information relating to a selection criteria associated with the second UE.
Aspect 18: The method of aspect 17, the discovery message comprising the first system information transmission.
Aspect 19: The method of aspect 17, the discovery message being transmitted via different signaling than the first system information transmission, the method further comprising: transmitting, to the first UE, a configuration of a periodicity of the first system information transmission, the transmitting of the first system information transmission being based at least in part on the configuration of the periodicity of the first system information transmission.
Aspect 20: The method of any of aspects 16 through 19, further comprising: receiving, from the base station, one or more SIBs; and generating the first system information transmission at the second UE based at least in part on the one or more SIBs, the transmitting of the first system information transmission being based at least in part on the generating of the first system information transmission at the second UE.
Aspect 21: The method of any of aspects 16 through 19, further comprising: receiving, from the base station via broadcast signaling, the first system information transmission, the transmitting of the first system information transmission being based at least in part on the receiving of the first system information transmission from the base station via the broadcast signaling.
Aspect 22: The method of any of aspects 16 through 21, further comprising: encoding the first system information transmission based at least in part on one or more ciphering and integrity protection algorithms.
Aspect 23: The method of aspect 22, further comprising: utilizing a group key in the encoding of the first system information transmission; and transmitting, to one or more UEs including the first UE, the group key.
Aspect 24: The method of any of aspects 22 through 23, further comprising: utilizing a system information broadcast key in the encoding of the first system information transmission; and transmitting, to the first UE, the system information broadcast key.
Aspect 25: The method of any of aspects 22 through 24, further comprising: transmitting, to the first UE, signaling triggering the establishing of the relay connection with the second UE; and transmitting, to the first UE, a confirmation of the first system information transmission over a unicast link secured for exclusive communication between the first UE and the second UE.
Aspect 26: The method of any of aspects 16 through 25, the connection state of the first UE being a connected state, and the receiving of the request associated with the base station for the second system information transmission comprising: receiving, from the first UE, a dedicated system information block request associated with the base station for the second system information transmission, the method further comprising: transmitting, to the base station, the dedicated system information block request; and receiving, from the base station, the second system information transmission in response to the dedicated system information block request, the transmitting of the second system information transmission to the first UE being based at least in part on the receiving of the second system information transmission from the base station.
Aspect 27: The method of any of aspects 16 through 25, the connection state of the first UE being an idle state or an inactive state, and the receiving of the request associated with the base station for the second system information transmission comprising: receiving, from the first UE, an indication of a request for a system information block via a radio resource control sidelink configuration information element, the method further comprising: performing an on-demand system information block acquisition procedure with the base station based at least in part on the receiving of the indication of the request for the system information block, the transmitting of the second system information transmission to the first UE being based at least in part on the performing of the on-demand system information block acquisition procedure with the base station.
Aspect 28: The method of any of aspects 16 through 27, the first system information transmission comprising an essential system information block and the second system information transmission comprising on-demand system information.
Aspect 29: An apparatus for wireless communication at a first UE, comprising a processor and memory coupled to the processor, the processor and memory configured to perform a method of any of aspects 1 through 15.
Aspect 30: An apparatus for wireless communication at a first UE, comprising at least one means for performing a method of any of aspects 1 through 15.
Aspect 31: A non-transitory computer-readable medium storing code for wireless communication at a first UE, the code comprising instructions executable by a processor to perform a method of any of aspects 1 through 15.
Aspect 32: An apparatus for wireless communication at a second UE, comprising a processor and memory coupled to the processor, the processor and memory configured to perform a method of any of aspects 16 through 28.
Aspect 33: An apparatus for wireless communication at a second UE, comprising at least one means for performing a method of any of aspects 16 through 28.
Aspect 34: A non-transitory computer-readable medium storing code for wireless communication at a second UE, the code comprising instructions executable by a processor to perform a method of any of aspects 16 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving, from a second UE via broadcast signaling, a first system information transmission comprising one or more parameters associated with a relay connection with the second UE;
transmitting, to the second UE, a request associated with a base station for a second system information transmission, the request based at least in part on the relay connection with the second UE and a connection state of the first UE, the relay connection based at least in part on the one or more parameters in the first system information transmission; and
receiving, from the second UE, the second system information transmission in response to the request.

2. The method of claim 1, further comprising:
receiving, from the second UE, a discovery message comprising a cell identifier associated with the second UE, a public land mobile network identifier associated with the second UE, and access stratum information relating to a selection criteria associated with the second UE.

3. The method of claim 2, the discovery message comprising the first system information transmission.

4. The method of claim 2, the discovery message being received via different signaling than the first system information transmission, the method further comprising:
receiving, from the second UE, a configuration of a periodicity of the first system information transmission, the receiving of the first system information transmission being based at least in part on the configuration of the periodicity of the first system information transmission.

5. The method of claim 4, the first system information transmission being received via a medium access control (MAC) control element, sidelink control information, packet data convergence protocol signaling, radio resource control signaling, or any combination thereof.

6. The method of claim 2, further comprising:
decoding the first system information transmission subsequent to receiving the discovery message and prior to the relay connection with the second UE.

7. The method of claim 2, further comprising:
selecting to establish the relay connection with the second UE based at least in part on the discovery message; and
decoding the first system information transmission based at least in part on establishing the relay connection with the second UE.

8. The method of claim 1, further comprising:
decoding the first system information transmission based at least in part on one or more ciphering and integrity protection algorithms.

9. The method of claim 8, further comprising:
receiving, from the second UE, a group key, the group key shared among one or more UEs including the first UE; and
utilizing the group key in the decoding of the first system information transmission.

10. The method of claim 8, further comprising:
receiving, from the second UE, a system information broadcast key; and
utilizing the system information broadcast key in the decoding of the first system information transmission.

11. The method of claim 8, further comprising:
receiving, from the second UE, signaling triggering the establishing of the relay connection with the second UE; and
receiving, from the second UE, a confirmation of the first system information transmission over a unicast link secured for exclusive communication between the first UE and the second UE.

12. The method of claim 1, further comprising:
receiving, from the second UE, one or more common system information blocks associated with the base station via a logical channel reserved for system information forwarding from the second UE to the first UE.

13. The method of claim 1, the connection state of the first UE being a connected state, and the transmitting of the request associated with the base station for the second system information transmission comprising:
transmitting, to the second UE, a dedicated system information block request associated with the base station for the second system information transmission.

14. The method of claim 1, the connection state of the first UE being an idle state or an inactive state, and the transmitting of the request associated with the base station for the second system information transmission comprising:
transmitting, to the second UE, an indication of a request for a system information block via a radio resource control sidelink configuration information element.

15. The method of claim 1, the first system information transmission comprising an essential system information block and the second system information transmission comprising on-demand system information.

16. A method for wireless communication at a second user equipment (UE), comprising:
transmitting, to a first UE via broadcast signaling, a first system information transmission comprising one or more parameters associated with a relay connection with the second UE;
receiving, from the first UE, a request associated with a base station for a second system information transmission, the request based at least in part on the relay connection with the first UE and a connection state of the first UE, the relay connection based at least in part on the one or more parameters in the first system information transmission; and
transmitting, to the first UE, the second system information transmission in response to the request.

17. The method of claim 16, further comprising:
transmitting, to the first UE, a discovery message comprising a cell identifier associated with the second UE, a public land mobile network identifier associated with the second UE, and access stratum information relating to a selection criteria associated with the second UE.

18. The method of claim 17, the discovery message comprising the first system information transmission.

19. The method of claim 17, the discovery message being transmitted via different signaling than the first system information transmission, the method further comprising:
transmitting, to the first UE, a configuration of a periodicity of the first system information transmission, the transmitting of the first system information transmission being based at least in part on the configuration of the periodicity of the first system information transmission.

20. The method of claim 16, further comprising:
receiving, from the base station, one or more system information blocks; and
generating the first system information transmission at the second UE based at least in part on the one or more system information blocks, the transmitting of the first system information transmission being based at least in part on the generating of the first system information transmission at the second UE.

21. The method of claim 16, further comprising:
receiving, from the base station via broadcast signaling, the first system information transmission, the transmitting of the first system information transmission being based at least in part on the receiving of the first system information transmission from the base station via the broadcast signaling.

22. The method of claim 16, further comprising:
encoding the first system information transmission based at least in part on one or more ciphering and integrity protection algorithms.

23. The method of claim 22, further comprising:
utilizing a group key in the encoding of the first system information transmission; and
transmitting, to one or more UEs including the first UE, the group key.

24. The method of claim 22, further comprising:
utilizing a system information broadcast key in the encoding of the first system information transmission; and
transmitting, to the first UE, the system information broadcast key.

25. The method of claim 22, further comprising:
transmitting, to the first UE, signaling triggering the establishing of the relay connection with the second UE; and
transmitting, to the first UE, a confirmation of the first system information transmission over a unicast link secured for exclusive communication between the first UE and the second UE.

26. The method of claim 16, the connection state of the first UE being a connected state, and the receiving of the request associated with the base station for the second system information transmission comprising:
receiving, from the first UE, a dedicated system information block request associated with the base station for the second system information transmission, the method further comprising:
transmitting, to the base station, the dedicated system information block request; and
receiving, from the base station, the second system information transmission in response to the dedicated system information block request, the transmitting of the second system information transmission to the first UE being based at least in part on the receiving of the second system information transmission from the base station.

27. The method of claim 16, the connection state of the first UE being an idle state or an inactive state, and the receiving of the request associated with the base station for the second system information transmission comprising:
receiving, from the first UE, an indication of a request for a system information block via a radio resource control sidelink configuration information element, the method further comprising:
performing an on-demand system information block acquisition procedure with the base station based at least in part on the receiving of the indication of the request for the system information block, the transmitting of the second system information transmission to the first UE being based at least in part on the performing of the on-demand system information block acquisition procedure with the base station.

28. The method of claim 16, the first system information transmission comprising an essential system information block and the second system information transmission comprising on-demand system information.

29. An apparatus for wireless communication at a first user equipment (UE), comprising:
a processor; and
memory coupled to the processor, the processor and memory configured to:
receive, from a second UE via broadcast signaling, a first system information transmission comprising one or more parameters associated with a relay connection with the second UE;
transmit, to the second UE, a request associated with a base station for a second system information transmission, the request based at least in part on the relay connection with the second UE and a connection state of the first UE, the relay connection based at least in part on the one or more parameters in the first system information transmission; and
receive, from the second UE, the second system information transmission in response to the request.

30. An apparatus for wireless communication at a second user equipment (UE), comprising:
a processor; and
memory coupled to the processor, the processor and memory configured to:
transmit, to a first UE via broadcast signaling, a first system information transmission comprising one or more parameters associated with a relay connection with the second UE;
receive, from the first UE, a request associated with a base station for a second system information transmission, the request based at least in part on the relay connection with the first UE and a connection state of the first UE, the relay connection based at least in part on the one or more parameters in the first system information transmission; and
transmit, to the first UE, the second system information transmission in response to the request.
